(19) United States
(12) Patent Application Publication
(10) Pub. No.: US 2010/0302259 A1
(43) Pub. Date: Dec. 2, 2010

(54) DRAWING DATA PROCESSING METHOD, GRAPHICS DRAWING SYSTEM AND GRAPHICS DRAWING DATA GENERATION PROGRAM

(75) Inventor: Ryohei Akita, Yokohama (JP)

Correspondence Address: STAAS & HALSEY LLP, SUITE 700, 1201 NEW YORK AVENUE, N.W., WASHINGTON, DC, 20005, US

(73) Assignee: Fujitsu Semiconductor Limited, Yokohama (JP)

(21) Appl. No.: 12/785,598

(22) Filed: May 24, 2010

(30) Foreign Application Priority Data
May 28, 2009 (JP) 2009-128800

(51) Int. Cl. G06T 1/00

(52) U.S. Cl. 345/501

(57) ABSTRACT

A drawing data processing method for arranging data concerning each of the plurality of vertices to generate a third list to be input in a drawing processor, the method include: selecting a first data generation process appropriate to the first and third data formats; selecting a second data generation process appropriate to the second and fourth data formats; computing an offset between vertices on the third list according to at least the third and fourth data formats; performing the first data generation process on the first data and writing the generated first data in a memory at intervals indicated by the offset; performing the second data generation process to generate the second data represented in the fourth data format for the plurality of vertices and writing the generated second data in the memory at the intervals indicated by the offset, wherein the method is performed by a processing unit.

### CROSS REFERENCE TO RELATED APPLICATION

This application is based upon and claims the benefit of priority from the prior Japanese Patent Application NO. 2009-128800 filed on May 28, 2009, the entire contents of which are incorporated herein by reference.

### FIELD

The embodiments discussed herein are related to drawing data processing for generating graphics drawing data on the basis of graphics data in image processing.

### BACKGROUND

In computer graphics, a graphics engine, which is a graphics drawing processor, computes an image to be displayed on the basis of graphics drawing data and writes the data on a pixel-by-pixel basis into a memory to generate display image data. Original graphics drawing data for two dimensional graphics is two-dimensional data; original graphics drawing data for three-dimensional graphics is three-dimensional data. In the case of three-dimensional graphics, the graphics engine computes an original two-dimensional image to be seen when a three-dimensional object given as three-dimensional data is viewed from a given angle and writes the data on a pixel-by-pixel basis in a memory to generate two-dimensional image data. Then a display engine reads the two-dimensional image data as drawing data from the memory and displays the read drawing data on a display device.

The graphics engine includes a geometry processor and a rasterizer. The geometry processor performs geometric processing such as scaling up and rotation of a three-dimensional object according to the position and posture of the object on the basis of tree-dimensional data of the three-dimensional object read from the memory. A three-dimensional object is typically represented as a collection of many polygons. The geometry processor performs coordinate transformation on a polygon-by-polygon basis as geometric processing and also performs computational processing such as light source computation. In the processing, a triangle, which is the simplest polygon, is commonly used. The geometry processor performs geometric processing and light source processing to compute data on the triangles making up a two-dimensional image of the object viewed from a given angle and provides data on the triangles to the rasterizer. If the original graphics drawing data is two-dimensional data, geometry processing does not need to be performed and graphics drawing data given may be directly provided to the rasterizer.

The rasterizer performs rasterization to fill in each pixel in each of the surfaces making up an object to generate two-dimensional drawing data. In the rasterization, the rasterizer obtains image parameters of each of the pixels contained in each triangle by interpolation based on image parameters obtained for each vertex of the triangle. The image parameters include the luminance of each of RGB colors, a Z-value which represents the distance of the pixel from the viewpoint in the depth direction, texture coordinates for texture display, and an alpha value for alpha blending.

Data on graphics to be drawn includes data such as vertex coordinate data indicating the coordinates of the vertices of triangles and vertex color data indicating the color of the vertices. In general, different applications generate graphics data in different data formats. For example, some software applications may use a fixed-point data format for both of vertex coordinate data and vertex color data to generate graphics data; other software applications may use a floating-point data format for both of vertex coordinate data and vertex color data to generate graphics data.

On the other hand, vertex coordinate data and vertex color data for graphics drawing data provided as input data to a drawing processor, which is a graphics engine, needs to be represented in a predetermined data format. For example, a drawing processor may request both vertex coordinate data and vertex color data of graphics drawing data to be represented in a floating-point data format. In that case, if vertex coordinate data and vertex color data of graphics data are generated in a fixed-point data format by a software application, the data format is requested to be converted. The data format conversion enables graphics drawing data suitable for the drawing processor to be generated from the graphics data appropriate to the application.

In addition to data format conversation, data arrangement of graphics data appropriate to an application needs to be converted to data arrangement of graphics drawing data suitable for the drawing processor. In graphics data generated by an application, typically a data list on which vertex coordinate data for multiple vertices are arranged and a data list on which vertex color data for the multiple vertices are arranged are separately kept. In a graphics processing device, on the other hand, vertex coordinate data and vertex color data on each vertex are combined together and a list on which the combined data on multiple vertices are arranged is provided as a single graphics drawing data list.

When data format conversion and data arrangement conversion described above are performed, conventionally the data format used for each vertex is determined, data format conversion is performed according to the determination, and the converted vertex coordinate data and vertex color data are written in a memory in an appropriate vertex-by-vertex arrangement. Specifically, the data format of vertex coordinate data for a first vertex is determined, the data format of the vertex coordinate data is converted according to the determination, and the converted vertex coordinate data for the first vertex is written in a memory. Then, the format of vertex color data for the first vertex is determined, the data format of the vertex color data is converted according to the determination, and the converted vertex color data for the first vertex is written in the memory. Graphics data provided includes data such as texture coordinate data representing the coordinates of a texture image applied to a triangle. Therefore, the data format of the texture coordinate data is also converted and all converted graphics drawing data on the first vertex, including the converted texture coordinate data, is written in the memory after the vertex coordinate data and the vertex color data. Then, the same process is performed for a second vertex. After all of converted graphics drawing data for the second vertex has been written in the memory, the same process is performed for a third vertex. The same process is performed for all of the remaining vertices.

In general, there are various data formats of vertex coordinate data, vertex color data, texture coordinate data and other data in graphics data generated by applications. Therefore there are a large number of combinations (for example more than 100 combinations) of the data formats. In terms of ease of maintenance, it is undesirable to provide different data conversion program codes for such a large number of different combinations because it would swell the code size. Therefore, conventionally the data format of each of vertex coordinate data, vertex color data and texture coordinate data is determined on a vertex-by-vertex basis and appropriate data conversion is performed on the basis of the determined data format as described above.

However, since the data format is determined on a vertex-by-vertex basis as described above, the number of executions of the data format determination process increases in proportion to the number of vertices contained in graphics data. Consequently, graphics data that contains many vertices may not efficiently be converted.

Related is disclosed in Japanese Laid-Open publication No. 9-22456.

### SUMMARY

According to one aspect of the present invention, there is provided a drawing data processing method in which if a plurality of lists including a first list on which first data in a first data format concerning a plurality of vertices are arranged vertex by vertex and a second list on which second data in a second data format concerning the plurality of vertices are arranged vertex by vertex are provided, data concerning each of the plurality of vertices are arranged for the plurality of vertices to generate a third list to be input in a drawing processor, the data including the first data represented in a third data format identical to or different from the first data format and the second data represented in a fourth data format identical to or different from the second data format, the method comprising the steps of:
selecting a first data generation process appropriate to the first and third data formats;
selecting a second data generation process appropriate to the second and fourth data formats;
computing an offset indicating the memory address distance between vertices on the third list according to at least the third and fourth data formats;
performing the first data generation process on the first data on the first list to generate the first data represented in the third data format for the plurality of vertices and writing the generated first data in a memory at intervals indicated by the offset;
performing the second data generation process on the second data on the second list to generate the second data represented in the fourth data format for the plurality of vertices and writing the generated second data in the memory at the intervals indicated by the offset;
wherein the method is performed by a processing unit.

The object and advantages of the embodiments will be realized and attained by means of the elements and combinations particularly pointed out in the claims.

It is to be understood that both the foregoing general description and the following detailed description and are exemplary and explanatory and are not restrictive of the embodiments, as claimed.

### BRIEF DESCRIPTION OF DRAWINGS

FIG. 1 is a diagram illustrating an exemplary configuration of a graphics drawing system;

FIG. 2 is a table illustrating an exemplary function that converts vertex coordinate data of graphics data to vertex coordinate data of graphics drawing data;

FIG. 3A, 3B, 3C are a table illustrating an exemplary function that convert vertex color data of graphics data to vertex color data of graphics drawing data;

FIG. 4 is a table illustrating an exemplary vertex command generation function that converts texture coordinate data of graphics data to texture coordinate data of graphics drawing data;

FIG. 5 is a flowchart illustrating an exemplary drawing data process operation performed by the graphics drawing system depicted in FIG. 1;

FIGS. 6A and 6B are a flowchart illustrating details of precomputation at step S2 of FIG. 5;

FIG. 7 is a table illustrating exemplary graphics drawing control data;

FIGS. 8A and 8B are a table illustrating the meanings of items of graphics drawing control data;

FIG. 9 is a table illustrating vertex coordinate command generation functions appropriate to combinations of the input data formats of vertex coordinate data and the output data formats of vertex commands;

FIG. 10 illustrates a selected vertex coordinate command generation function;

FIG. 11 is a table illustrating the meanings of vertex_strides of graphics drawing control data;

FIG. 12 illustrates exemplary data indicating the offset to the next vertex coordinate data;

FIG. 13 illustrates exemplary data indicating the address of the location from which vertex coordinate data is to be obtained;

FIG. 14 is a table illustrating vertex color command generation functions appropriate to combinations of the input data formats of vertex color data and the output data formats of vertex commands;

FIG. 15 illustrates data representing a selected vertex color command generation function;

FIG. 16 is a table illustrating the meanings of color_strides of graphics drawing control data;

FIG. 17 illustrates exemplary data indicating the offset to the next vertex color data;

FIG. 18 illustrates exemplary data indicating the address of the location from which vertex color data is to be obtained;

FIG. 19 is a table illustrating texture coordinate command generation functions appropriate to combinations of the input data formats of texture coordinate data and the output data formats of vertex commands;

FIG. 20 illustrates data representing a selected texture coordinate command generation function;

FIG. 21 is a table illustrating the meanings of texture_strides of graphics drawing control data;

FIG. 22 illustrates exemplary data indicating the offset to the next texture coordinate data;

FIG. 23 illustrates exemplary data indicating the address of the location from which texture coordinate data is to be obtained;

FIG. 24 illustrates exemplary data indicating the storage location address of a vertex coordinate command;

FIG. 25 is a table illustrating the sizes of vertex coordinate commands associated with vertex coordinate command generation functions;

FIG. 26 illustrates exemplary data indicating the storage location address of a vertex color command;

FIG. 27 is a table illustrating the sizes of vertex color commands associated with vertex color command generation functions;

FIG. 28 illustrates an example of data indicating the storage location address of a texture coordinate command;

FIG. 29 is a table illustrating the sizes of texture coordinate commands associated with texture coordinate command generation functions;

FIG. 30 illustrates exemplary data indicating the offset to the next vertex command storage location address;

FIG. 31 is a flowchart illustrating details of graphics drawing data generation at step S3 of FIG. 5;

FIG. 32 illustrates data precomputed from the exemplary graphics drawing control data illustrated in FIG. 7;

FIG. 33 illustrates how various setting commands and a graphics drawing start command are stored from the address indicated by DL_ptr in a VRAM memory space;

FIG. 34 illustrates arguments used in calling a vertex coordinate command generation function in the case of the exemplary precomputed data illustrated in FIG. 32;

FIG. 35 is a flowchart illustrating details of vertex coordinate command generation by a vertex coordinate command generation function;

FIG. 36 is a diagram schematically illustrating the vertex coordinate command generation process by the vertex coordinate command generation function;

FIG. 37 illustrates arguments used in calling a vertex color command generation function in the case of the exemplary precomputed data illustrated in FIG. 32;

FIG. 38 is a flowchart illustrating details of vertex color command generation by a vertex color command generation function;

FIG. 39 is a diagram schematically illustrating vertex color command generation process by the vertex color command generation function;

FIG. 40 illustrates arguments used in calling a texture coordinate command generation function in the case of the exemplary precomputed data illustrated in FIG. 32;

FIG. 41 is a flowchart illustrating details of texture coordinate command generation by a texture coordinate command generation function;

FIG. 42 is a diagram schematically illustrating the texture coordinate command generation process by the texture coordinate command generation function;

FIG. 43 is a diagram illustrating a structure of graphics drawing data generated in a VRAM memory space;

FIGS. 44A and 44B are a flowchart illustrating a conventional graphics drawing data generation process;

FIG. 45 is a table illustrating processing loads in the conventional graphics drawing data generation process illustrated in FIGS. 44A and 44B;

FIGS. 46A and 46B are a table illustrating processing loads in the graphics drawing data generation process at steps S2 and S3 of FIG. 5;

FIG. 47 is a flowchart illustrating two graphics drawing processes selectively performed in an embodiment;

FIG. 48 is a flowchart of a process for setting a threshold value used in the determination at step S1 of FIG. 47;

FIG. 49 is a diagram illustrating a variation of the graphics drawing system;

FIG. 50 is a flowchart illustrating a graphics drawing process using a multi-core CPU depicted in FIG. 49; and

FIGS. 51A and 51B are a table illustrating processing loads in the graphics drawing data generation process at steps S2 and S3-1 through S3-3 of FIG. 50.

### DESCRIPTION OF EMBODIMENTS

Exemplary embodiments of the present invention will be described below in detail with reference to the accompanying drawings.

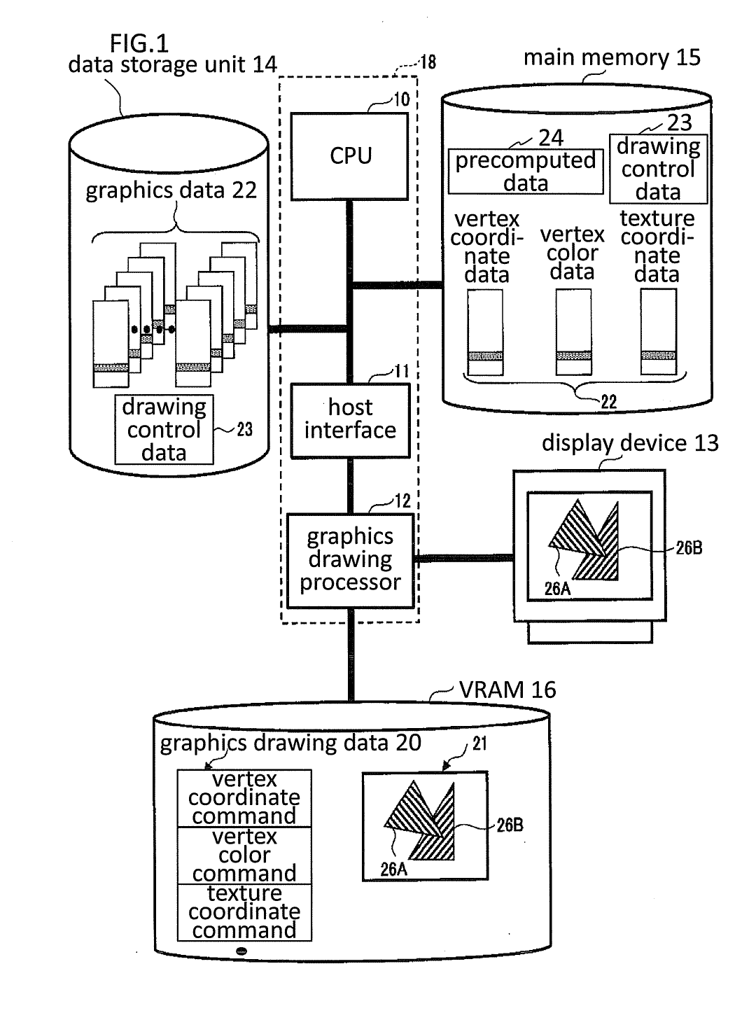

FIG. 1 illustrates an exemplary configuration of a graphics drawing system. The graphics drawing system illustrated in FIG. 1 includes a central processing unit (CPU) 10, a host interface 11, a graphics drawing processor 12, a display device 13, a data storage unit 14, a main memory 15, and a video random access memory (VRAM) 16. The CPU 10 is coupled to the graphics drawing processor 12 through the host interface 11. The CPU 10 and the graphics drawing processor 12 coupled with each other may be integrated into a single drawing system chip 18. The couplings of the display device 13, the data storage unit 14, the main memory 15, and the VRAM 16 onto the drawing system chip 18 in FIG. 1 are schematic or functional ones, rather than actual couplings of signal lines. For example, the main memory 15 and the VRAM 16 do not need to be separate memory devices; they may be a single memory device that forms one contiguous memory space connected to the drawing system chip 18. The data storage unit 14 may be a mass data storage device such as a hard disk drive, DVD, or CD-ROM. The display device 13 is a display such as a CRT or liquid-crystal display which displays two-dimensional image data (raster data) written on the VRAM 16.

The graphics drawing processor 12 computes an image to be displayed on the basis of graphics drawing data 20 stored in the VRAM 16 and writes data for each pixel of the image into the memory to generate two-dimensional image data (raster data) 21. Original graphics drawing data 20 for two-dimensional graphics is two-dimensional data; original graphics drawing data 20 for three-dimensional graphics is three-dimensional data. In the case of three-dimensional graphics, the graphics drawing processor 12 computes a two-dimensional image of a three-dimensional object provided as three-dimensional data that is to be viewed from a given angle and writes the data for each pixel in the memory to generate two-dimensional image data 21. Then, a display engine contained in the graphics drawing processor 12 reads the two-dimensional image data 21 from the VRAM 16 as drawing data and displays the read drawing data on the display device 13.

The graphics drawing processor 12 performs geometry processing and rasterization. The graphics drawing processor 12 performs geometric processing such as scaling up and rotation of a three-dimensional object according to the position and posture of the object on the basis of tree-dimensional data (graphics drawing data 20) of the three-dimensional object read from the VRAM 16. A three-dimensional object is typically represented as a collection of many polygons. In the geometry processing, coordinate transformation is performed on a polygon-by-polygon basis as geometric computational processing and computational processing such as light source computation is performed. In the processing, a triangle, which is the simplest polygon, is commonly used. In the geometry processing, geometric processing and light source processing are performed to compute data on the triangles making up a two-dimensional image of the object viewed from a given angle. The data on the triangles is then provided to the rasterization. If the original graphics drawing data 20 is two-dimensional data, geometry processing does not need to be performed and the graphics drawing data 20 given may be directly subjected to the rasterization.

In the rasterization, rasterization for filling in each pixel in each surface of the object is performed to generate two-dimensional drawing data (two-dimensional image data 21). In the rasterization, image parameters of each of the pixels contained in each triangle are obtained by using interpolation based on image parameters obtained for each vertex of the triangle. The image parameters include the luminance of each of RGB colors, a Z-value which represents the distance of the pixel from the viewpoint in the depth direction, texture coordinates for texture display, and an alpha value for alpha blending.

The graphics drawing data 20 is generated by the CPU 10 on the basis of graphics data 22 and graphics drawing control data 23 stored in the data storage unit 14. The graphics data 22 includes data such as vertex coordinate data representing the coordinates of the vertices of the triangles, vertex color data representing the colors of the vertices, and texture coordinate data indicating the coordinates of texture images to be applied to the triangles. The graphics data 22 is represented in a data format appropriate to the software application that uses the graphics data 22.

The graphics data 22 is multiple lists including a first list on which first data in a first data format concerning multiple vertices are arranged on a vertex-by-vertex basis and a second list on which second data in a second data format concerning the vertices are arranged on a vertex-by-vertex basis. Here, the first data is vertex, coordinate data and the second data is vertex color data, for example. The CPU 10 arranges data concerning the multiple vertices that includes the first data represented in a third data format identical to or different from the first data format and the second data represented in a fourth data format identical to or different from the second data format vertex by vertex to generate graphics drawing data 20.

First, the CPU 10 reads the graphics data 22 and the graphics drawing control data 23 from the data storage unit 14 and stores them in the main memory 15. Based on the graphics data 22 and the graphics drawing control data 23 in the main memory 15, the CPU 10 first generates precomputed data 24. Specifically, the CPU 10 selects a first data generation process appropriate to the first and third data formats. The CPU 10 also selects a second data generation process appropriate to the second and forth data formats. The CPU 10 computes an offset indicating the distance between the memory addresses of vertices in the graphics drawing data 20 according to at least the third and fourth data formats. The process described above is performed first as precomputation for generating the graphics drawing data 20 to generate precomputed data 24. The precomputed data 24 includes at least data identifying the first and second data generation processes, as well as data representing the offset.

Based on the precomputed data 24 obtained as described above, the CPU 10 writes the graphics drawing data 20 into the VRAM 16. First, the CPU 10 performs the first data generation process on the first data on the first list to generate the first data represented in the third data format for multiple vertices and writes the generated first data into the VRAM 16 at intervals indicated by the offset. The CPU 10 performs the second data generation process on the second data on the second list to generate the second data represented in the fourth data format and writes the generated second data into the VRAM 16 at the intervals indicated by the offset. In this way, the first data (for example vertex coordinate data) in the converted data format and the second data (for example vertex color data) in the converted data format are written in the VRAM 16 at the predetermined offset intervals on the vertex-by-vertex basis to generate graphics drawing data 20. Similarly, the data format of the other data included in the graphics data 22, for example texture coordinate data, is also converted and the data in the converted data format may be written in the VRAM 16 at the predetermined offset intervals.

The step of performing the first data generation process to generate the first data represented in the third data format for multiple vertices and write the generated first data in the VRAM 16 at the intervals indicated by the offset (the step is referred to as the first step, for convenience) may be performed for the multiple vertices at a time. The step of performing the second data generation process to generate the second data represented in the fourth data format for multiple vertices and write the generated second data in the VRAM 16 at the intervals indicated by the offset (the step is referred to as the second step, for convenience) may be performed for the multiple vertices at a time. The first and second steps may be separately performed. Specifically, one of the first and second steps may be performed first and then the other may be performed, or the first and second steps may be independently performed in parallel. In this way, high efficiency may be achieved by setting the sequence of the first and second data generation processes or parallel execution of the first and second data generation processes beforehand and then performing each of the first step of using the first data generation process and the second step of using the second data generation process on multiple vertices at a time.

The step of generating the first data represented in the third data format for multiple vertices and writing the first data thus generated in the VRAM 16 at intervals indicated by the offset may be performed by calling a first function corresponding to the first data generation process. The step of generating the second data represented in the fourth data format for multiple vertices and writing the second data thus generated in the VRAM 16 at the intervals indicated by the offset may be performed by calling a second function corresponding to the second data generation process.

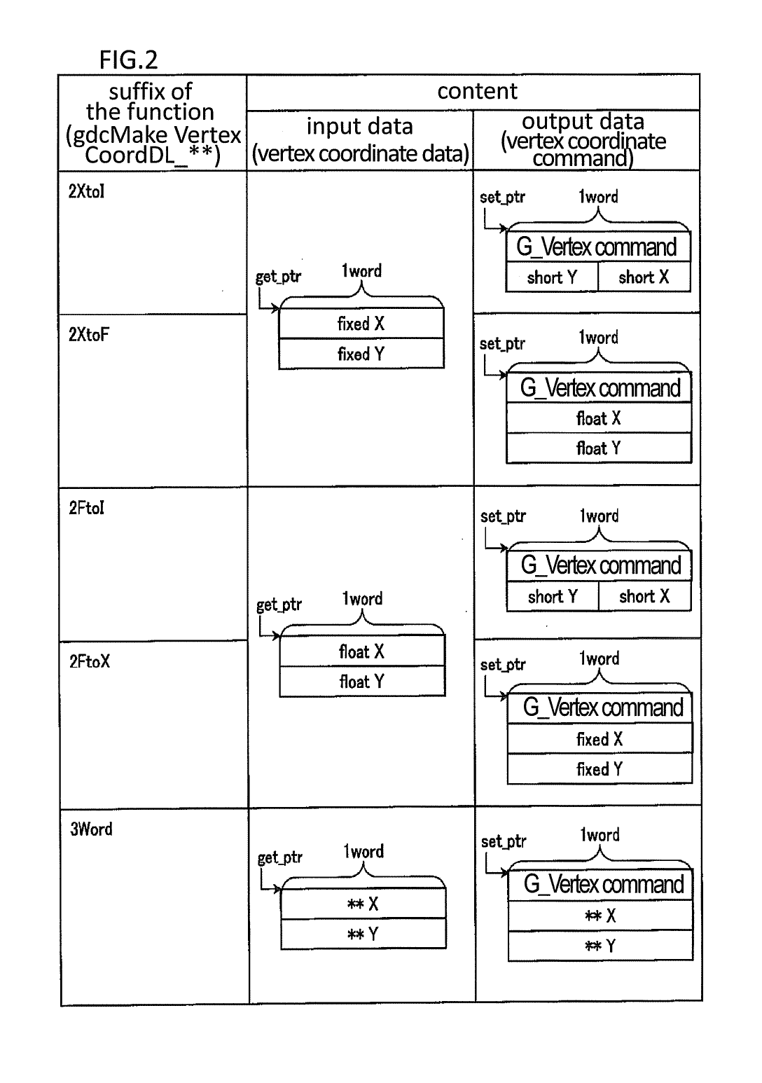

FIG. 2 is a table illustrating an exemplary function that converts vertex coordinate data of graphics data 22 to vertex coordinate data of graphics drawing data 20. The vertex coordinate data of the graphics drawing data 20 indicates the coordinates of vertices to be drawn to the graphics drawing processor 12 and is called vertex coordinate command. On the other hand, a function that converts vertex coordinate data of the graphics data 22 to vertex coordinate data (that is, a vertex coordinate command) of the graphics drawing data 20 is called vertex coordinate command generation function. In the example illustrated in FIG. 2, the vertex coordinate command generation function is given the name “gdcMakeVertexCoordDL_**”. A suffix such as “2XtoI” or “2XtoF” is specified in the suffix section “**” of the function to specify the format of data conversion performed by the function. In the example illustrated in FIG. 2, “2XtoI” indicates that single-word (4-byte) X and Y coordinate values in a fixed-point data format (fixed) are given as input data and short-format (2-byte) integer X and Y coordinate values are generated as output data. “2XtoF” indicates that single-word (4-byte) X and Y coordinate values in a fixed format (fixed) are given as input data and single-word X and Y coordinate values in a floating format (float) are generated as output data. The suffix “2FtoX” indicates that single-word (4-byte) X and Y coordinate values in a floating-point data format (float) are given as input data and single-word X and Y coordinate values in a fixed-point data format (fixed) are generated as output data. The suffix “3Word” indicates that single-word X and Y coordinate values are given as input data and a single-word G_Vertex command and single-word X and Y coordinate values are generated as 3-word (in total) output data. Here, the G_Vertex command is a single-word fixed bit-pattern indicating that any of various kinds of vertex data on one vertex follows the fixed bit pattern. The graphics drawing processor 12 recognizes the data stored between a G_Vertex command and the next G_Vertex command as vertex data on one vertex. In the table in FIG. 2, “get_ptr” indicates the address of the location from where the vertex coordinate data of the graphics data 22 is to be obtained and “set_ptr” indicates the storage location address of the vertex coordinate command of the graphics drawing data 20.

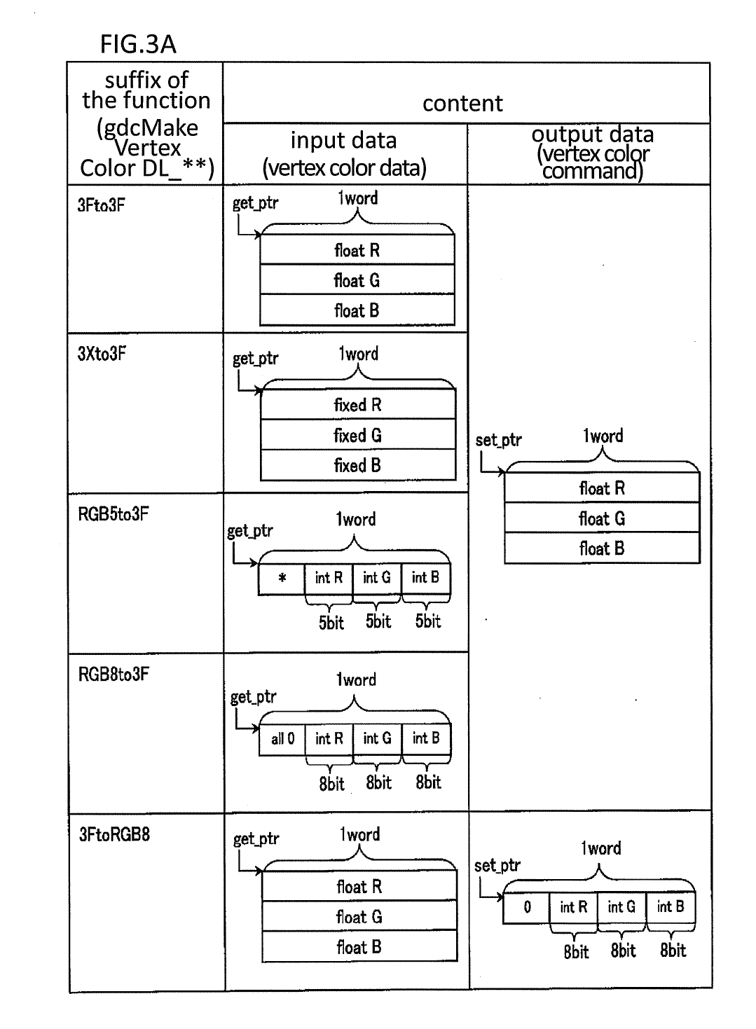

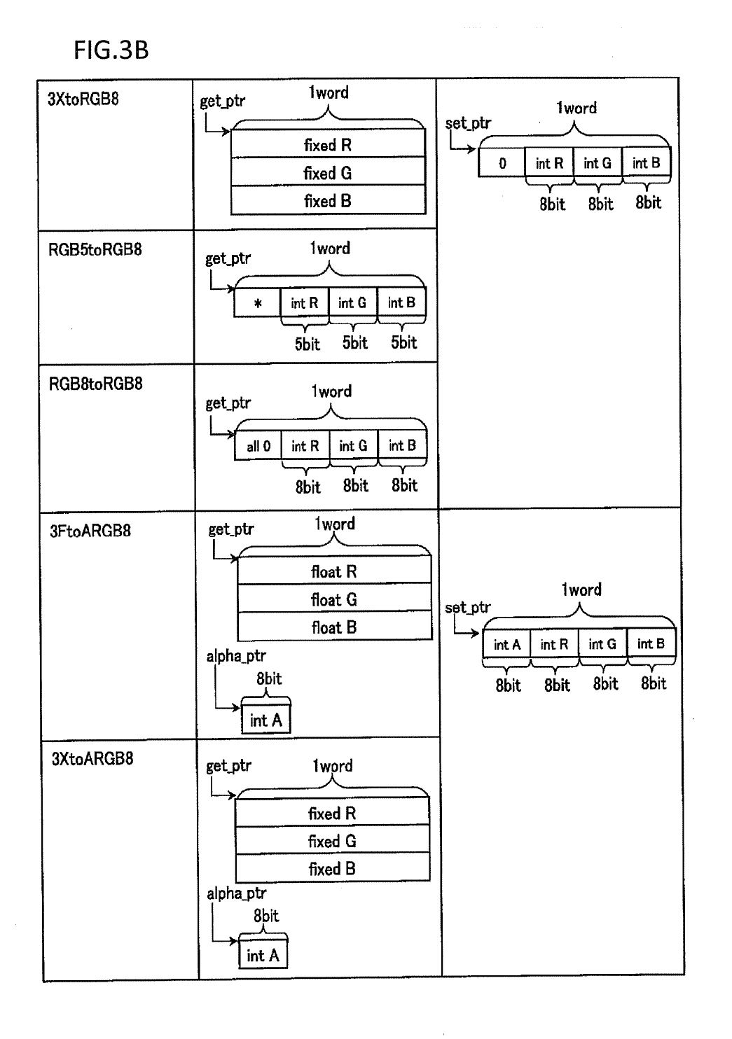

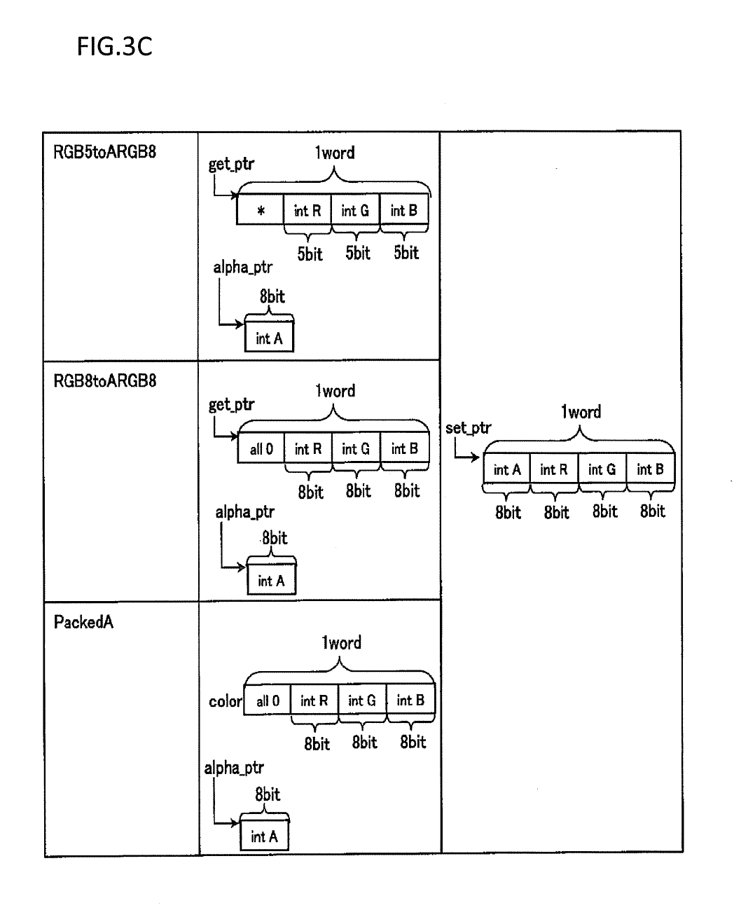

FIGS. 3A through 3C are tables illustrating an exemplary function that converts vertex color data of graphics data 22 to vertex color data of graphics drawing data 20. The function that converts the vertex color data of graphics data 22 to vertex color data of graphics drawing data 20 (that is, a vertex color command) is called vertex color command generation function. In the example illustrated in FIGS. 3A through 3C, the vertex color command generation function is given the name “gdcMakeColorDL_**”. A suffix such as “3Fto3F” or “3Xto3F” is specified in the suffix section “**” of the function to specify the format of data conversion by the function. For example, “3Fto3F” in FIG. 3A indicates that single-word (4-byte) RGB color values in a floating-point data format (float) are given as input data and single-word RGB color values in the floating-point data format (float) are generated as output data. In FIG. 3B, “3XtoARGB8” indicates that single-word (4-byte) RGB color values in a fixed-point data format (fixed) and an 8-bit alpha value A in an integer format (int) are given as input data. The function generates a single-byte alpha value A and single-byte RGB color values in an integer format (int) as output data. Here, “alpha_ptr” indicates the address from where alpha value (alpha coefficient) data is to be obtained and “color” is a fixed color value used when the color array is disabled.

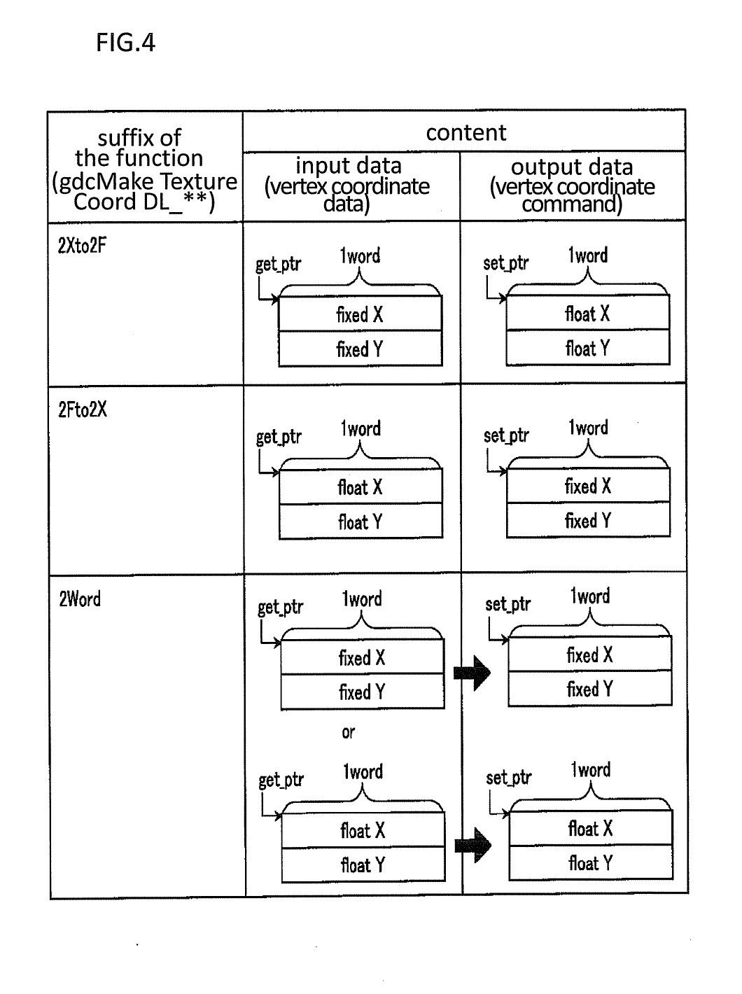

FIG. 4 is a table illustrating an exemplary vertex command generation function that converts texture coordinate data of graphics data 22 to texture coordinate data of graphics drawing data 20. The function that converts texture coordinate data of graphics data 22 to texture coordinate data of graphics drawing data 20 (that is, a texture coordinate command) is called texture coordinate command generation function. In the example illustrated in FIG. 4, the texture coordinate command generation function is given the name “gdcMakeTextureCoordDL_**”. A suffix such as “2Xto2F” or “2Fto2X” is specified in the suffix section “**” of the function to specify the format of data conversion by the function. Details of the example are the same as those illustrated in FIGS. 2 and 3A through 3C and therefore the description of the details will be omitted.

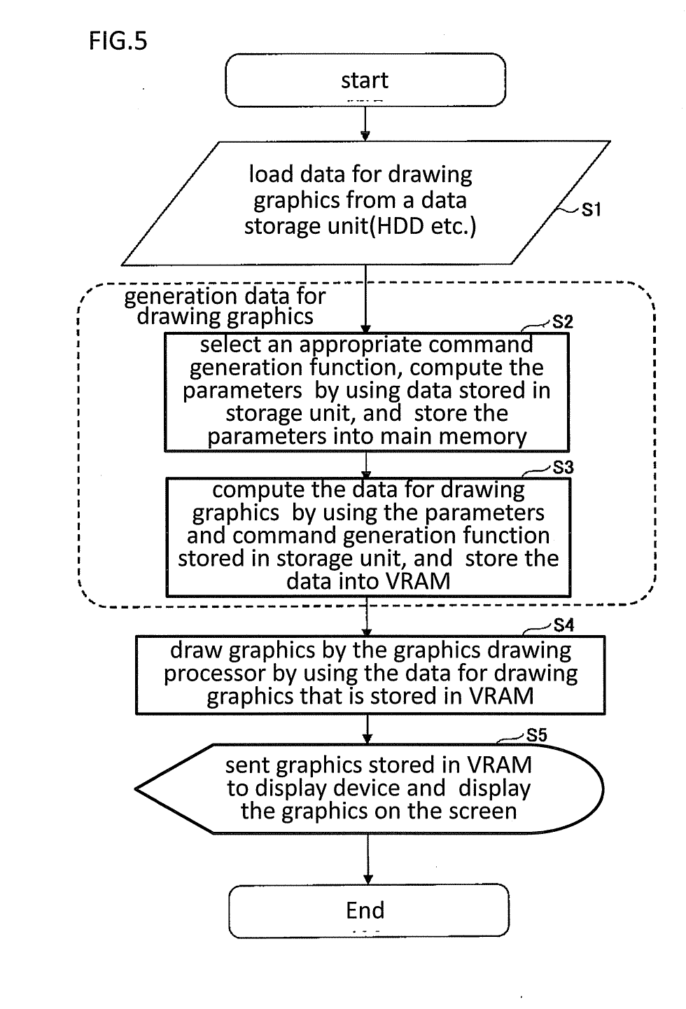

FIG. 5 is a flowchart illustrating an exemplary drawing data processing performed by the graphics drawing system depicted in FIG. 1. At step S1, the CPU 10 loads graphics data 22 and graphics drawing control data 23 from the data storage unit 14 into the main memory 15. At step S2, the CPU 10 selects a command generation function most appropriate to vertex command generation on the basis of the graphics data 22 and the graphics drawing control data 23 stored in the main memory 15. For example, the CPU 10 selects the most appropriate one of the vertex command generation functions illustrated in FIGS. 2 through 4. The CPU 10 computes parameters such as an address value and an offset value to be contained in the selected vertex command generation function on the basis of the graphics data 22 and the graphics drawing control data 23 stored in the main memory 15. The data representing the selected vertex command generation function and the computed parameters are stored in the main memory 15 as precomputed data 24. The precomputed data 24 may be stored and managed separately from the graphics drawing control data 23 or may be stored and managed as part of the graphics drawing control data 23. At step S3, the CPU 10 executes the selected vertex command generation function to generate graphics drawing data 20 on the basis of the graphics drawing control data 23 and the precomputed data 24 and stores the generated graphics drawing data 20 in the VRAM 16. With this, the process for generating the graphics drawing data 20 ends.

The graphics drawing data 20 generation process performed by the CPU 10 is implemented by the CPU 10 executing a given program. The program is stored in the data storage unit 14 and is loaded into the main memory 15 at execution time. The main memory 15 also functions as a working memory during the execution of the program. The vertex command generation functions are stored in the data storage unit 14 as library functions, for example, beforehand. The CPU 10 loads a selected vertex command generation function from the data storage unit 14 into the main memory 15 and executes the vertex command generation function.

At step S4 of FIG. 5, the graphics drawing processor 12 draws graphics as raster data on the basis of the graphics drawing data 20 to generate two-dimensional image data 21 and stores the two-dimensional image data 21 in the VRAM 16. Specifically, the graphics drawing processor 12 performs geometric processing such as scaling up and rotation of an object according to three-dimensional data (the graphics drawing data 20) on the object and computes data on the multiple two-dimensional triangles making up a two-dimensional image of the object viewed from a desired angle. If the original graphics drawing data 20 is two-dimensional data, the geometric processing does not need to be performed. After that, the graphics drawing processor 12 performs rasterization to fill in each of the pixels of the surfaces making up the object on the basis of data on the multiple two-dimensional triangles to generate two-dimensional drawing data (two-dimensional image data 21). In the rasterization, image parameters of each of the pixels contained in each triangle are obtained by interpolation or otherwise to fill in the triangles on the basis of image parameters obtained for the vertices of each triangle. For example, suppose two triangles 26A and 26B are to be drawn as depicted in FIG. 1. In this case, image parameters for the three vertices of triangle 26A are obtained from the vertex data of the graphics drawing data 20 and the image parameters are interpolated to obtain image parameters (such as luminance, color and texture) of the pixels in triangle 26A to draw triangle 26A. Likewise, image parameters for the three vertices of triangle 26B are obtained from the vertex data of the graphics drawing data 20 and the image parameters are interpolated to obtain image parameters (such as luminance, color and texture) of the pixels in triangle 26B to draw triangle 26B. Z-values which indicate the distance of the pixels from the viewpoint in the depth direction are compared to determine that a portion of triangle 26B is hidden behind triangle 26A, so that triangles 26A and 26B may be drawn with proper depth ordering.

At step S5, a drawing engine of the graphics drawing processor 12 transfers the two-dimensional image data 21 from the VRAM 16 to the display device 13 to display drawing data on the screen of the display device 13. Thus, two triangles 26A and 26B are displayed on the screen of the display device 13 as depicted in FIG. 1, for example.

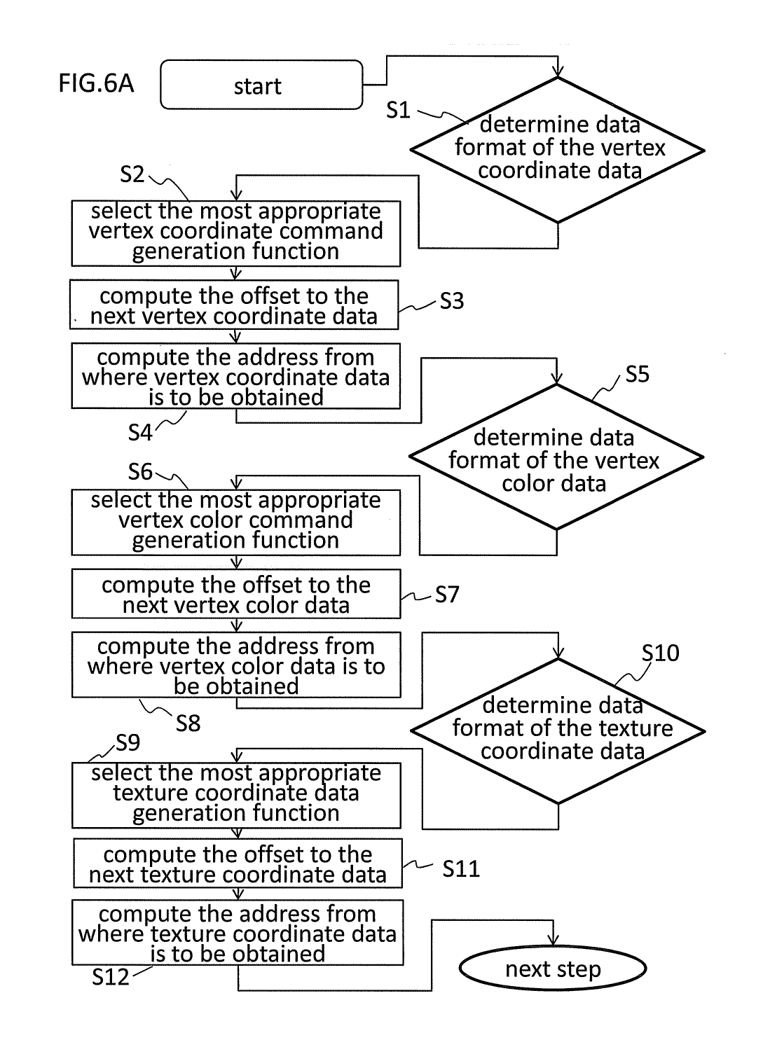

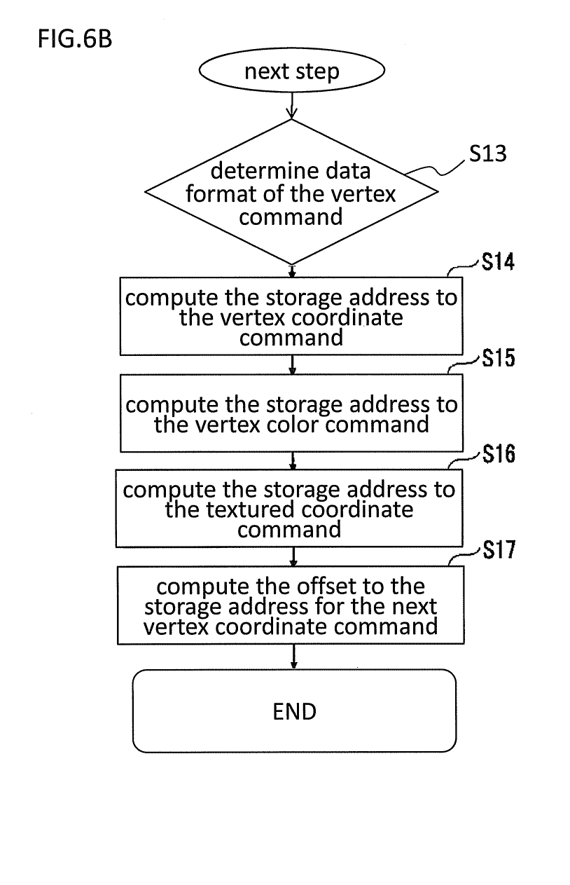

FIGS. 6A and 6B are a flowchart illustrating details of the precomputation at step S2 of FIG. 5. The steps of FIG. 6 are performed by the CPU 10 depicted in FIG. 1. At step S1, the CPU 10 determines the input and output data formats of vertex coordinate data. The determination is made with reference to the data indicating input and output data formats of vertex coordinate data contained in the graphics drawing control data 23.

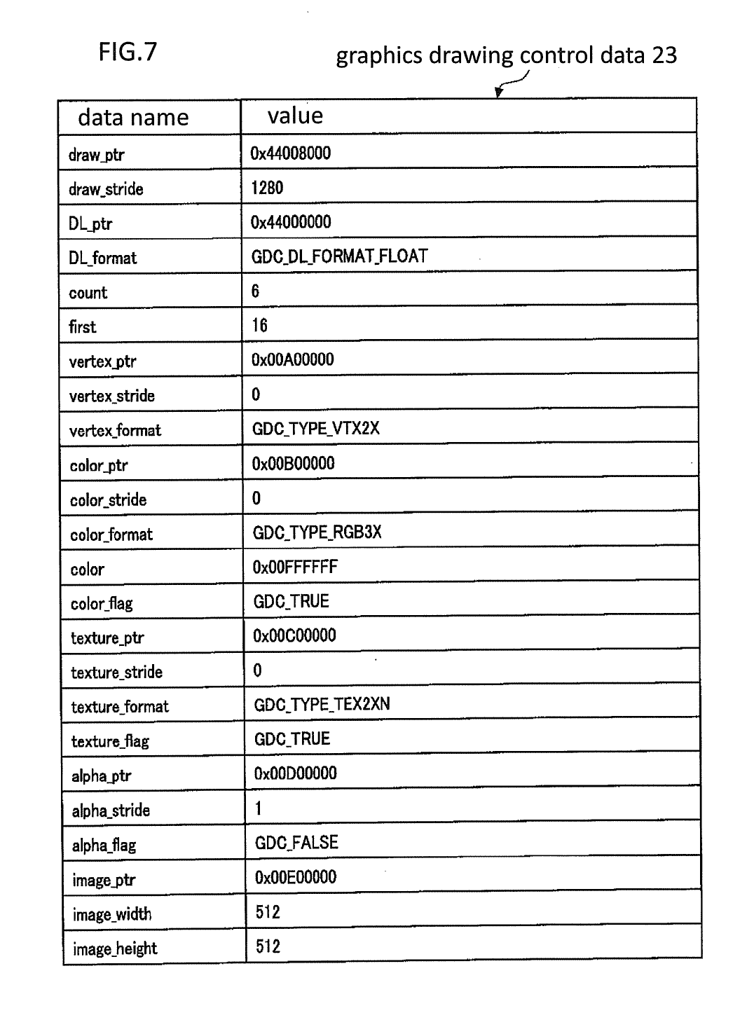

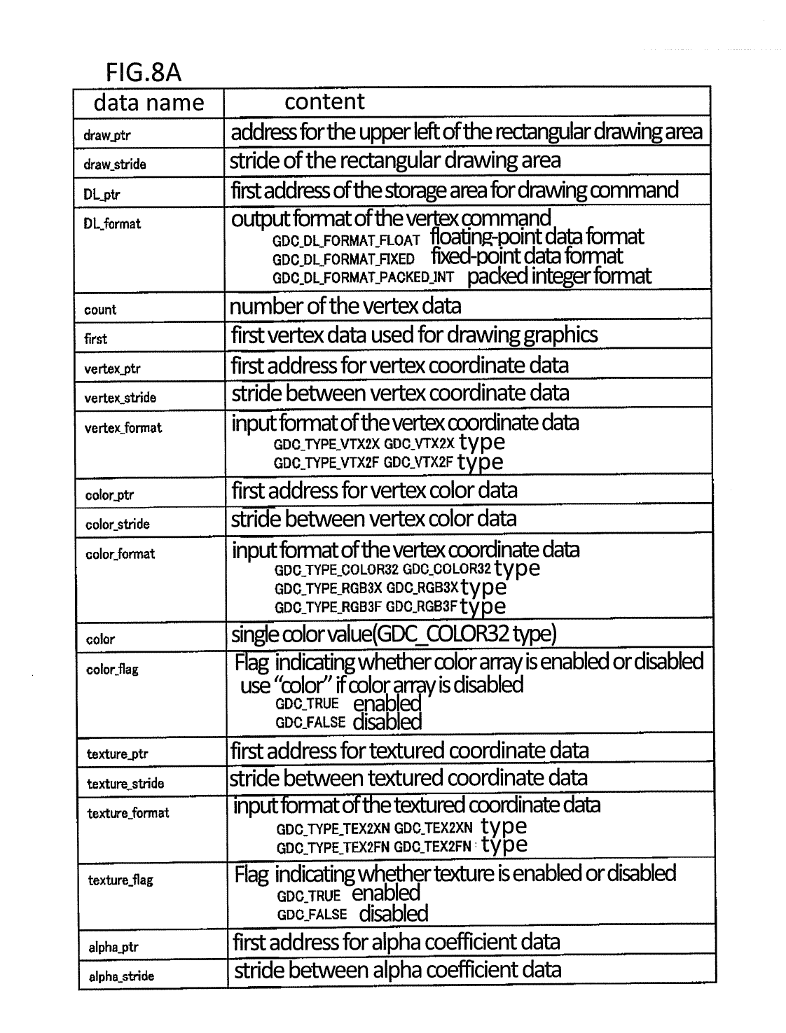

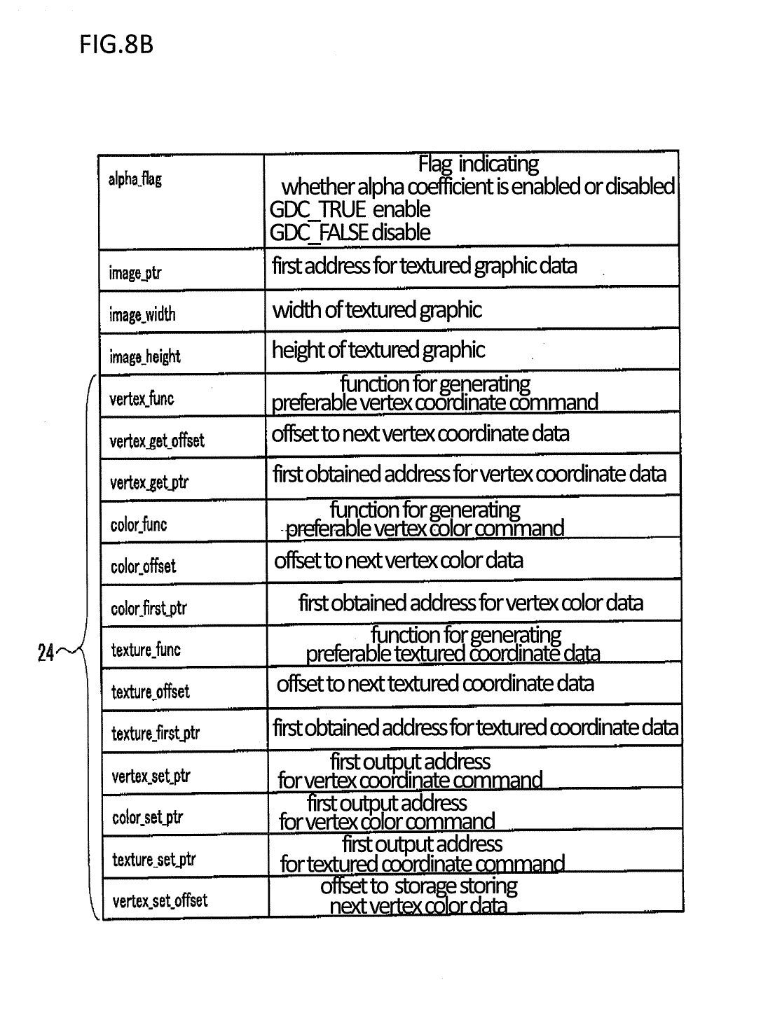

FIG. 7 is a table illustrating exemplary graphics drawing control data 23. As illustrated in FIG. 7, in the graphics drawing control data 23, values of items of data having unique names and certain meanings are defined. The values specify drawing conditions for an object to be drawn. The meanings of the items of data in the graphics drawing control data 23 are listed in the tables in FIGS. 8A and 8B. In FIG. 8B, the data with the data name “vertex_func” and the subsequent data correspond to the precomputed data 24 obtained from the precomputation in FIG. 6. As has been described, the precomputed data 24 may be managed as part of the graphics drawing control data 23.

In the exemplary graphics drawing control data 23 in FIG. 7, the input format of vertex coordinate data indicated by the data with the data name “vertex_format” is “GDC_TYPE_VTX2X”. That is, it is determined at step S1 of FIG. 6 that the input data format of the vertex coordinate data is “GDC_TYPE_VTX2X” (a floating-point data format). In the exemplary graphics drawing control data 23 in FIG. 7, the output format of the vertex command represented by the data with the data name “DL_format” is “GDC_DL_FORMAT_FLOAT”. That is, it is determined at step S1 of FIG. 6 that the output data format of the vertex command is the floating-point data format.

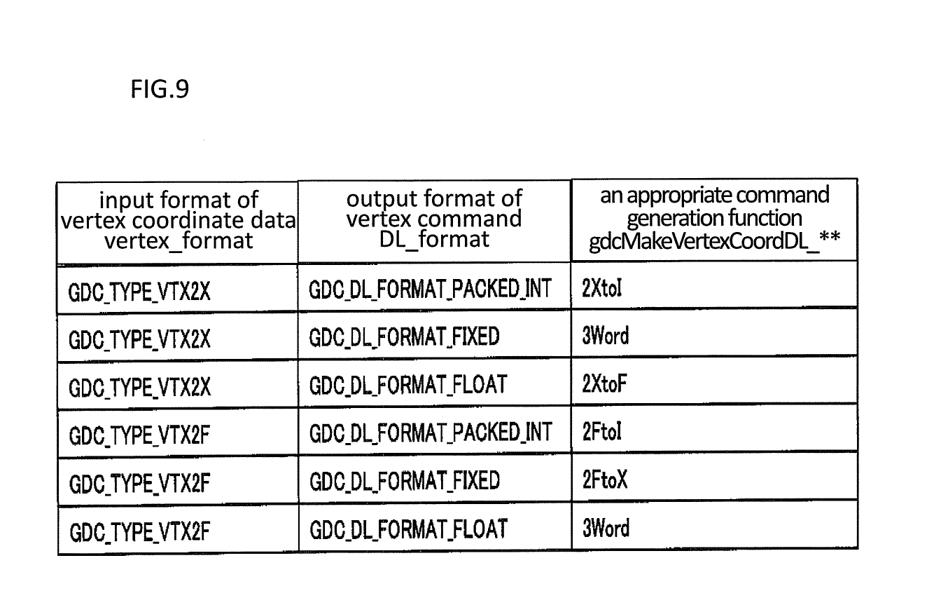

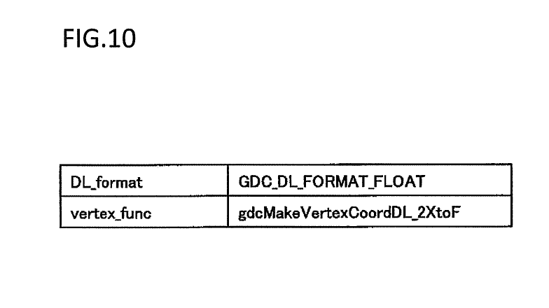

At step S2 of FIG. 6, the CPU 10 selects the most appropriate vertex coordinate command generation function. FIG. 9 is a table illustrating vertex coordinate command generation functions appropriate to combinations of input data formats of vertex coordinate data and output data formats of a vertex commands. In the exemplary graphics drawing control data 23 illustrated in FIG. 7, the input format of the vertex coordinate data is “GDC_TYPE_VTX2X” and the output format of the vertex command is “GDC_DL_FORMAT_FLOAT” as stated above. Accordingly, the vertex coordinate command generation function appropriate to the combination, that is, the function “gdcMakeVertexCoordDL_{—}2XtoF”, is selected from the table of FIG. 9. Thus, “gdcMakeVertexCoordDL_{—}2XtoF” is stored as the value of the data with the data name “vertex_func” in the precomputed data 24 (or as part of the graphics drawing control data 23). This is illustrated in FIG. 10.

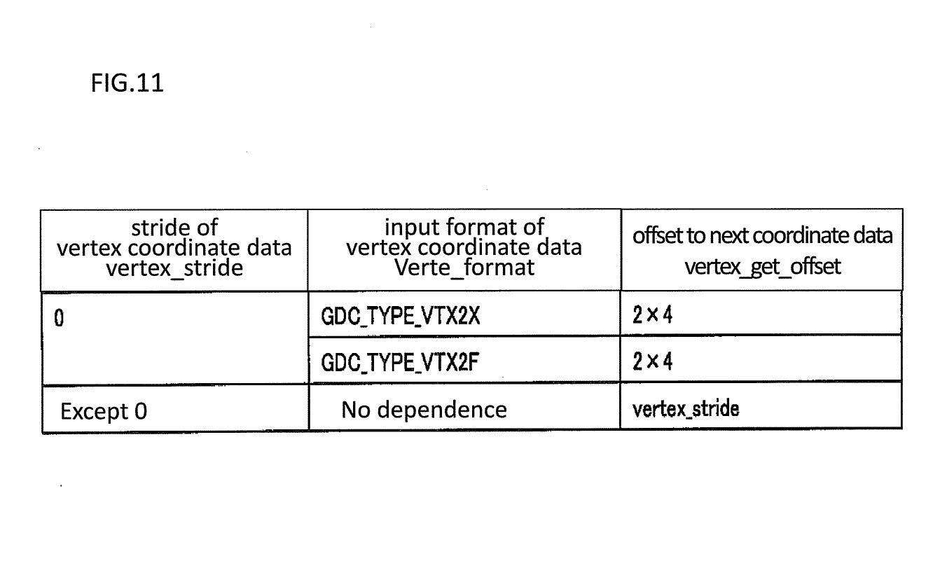

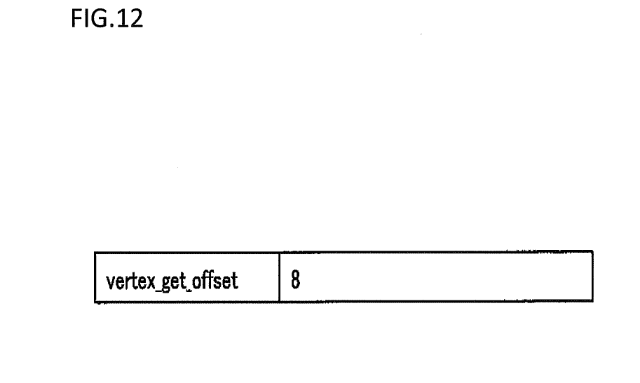

At step S3 of FIG. 6, the CPU 10 then computes the offset to the next vertex coordinate data. The offset may be obtained by referring to the value of “vertex_stride” in the graphics drawing control data 23. In the exemplary graphics drawing control data 23 in FIG. 7, the value of “vertex_stride” is 0, the meaning of which is given in FIG. 11. When the value of “vertex_stride” in the graphics drawing control data 23 is 0, the value of the offset to the next vertex coordinate data is determined depending on the input format of the vertex coordinate data as illustrated in FIG. 11. When the value of “vertex_stride” in the graphics drawing control data 23 is non-zero, the value of “vertex_stride” is equal to the value of the offset to the next vertex coordinate data regardless of the input format of the vertex coordinate data. Since the value of “vertex_stride” is 0 and the input format of the vertex coordinate data is “GDC_TYPE_VTX2X” in the exemplary graphics drawing control data 23 in FIG. 7, the offset to the next vertex coordinate data is 2×4. Accordingly, 8 is stored as the value of the data with the data name “vertex_get_offset” in the precomputed data 24 (or as part of the graphics drawing control data 23). This is illustrated in FIG. 12.

At step S4 of FIG. 6, the CPU 10 computes the address from where vertex coordinate data is to be obtained. The address “vertex_get_ptr” from where vertex coordinate data is to be obtained may be computed according to the following equation.

vertex_get_{—}ptr=vetex_{—}ptr+(vetex_get_offfset×first)

where “vertex_ptr” and “first” are data defined in the graphics drawing control data 23 and “vertex_get_offset” is the offset value obtained at step S3 as described above. In the case of the exemplary graphics drawing control data 23 in FIG. 7,

vertex_get_{—}ptr=0x00A00000+(8×16)=0x00A00080

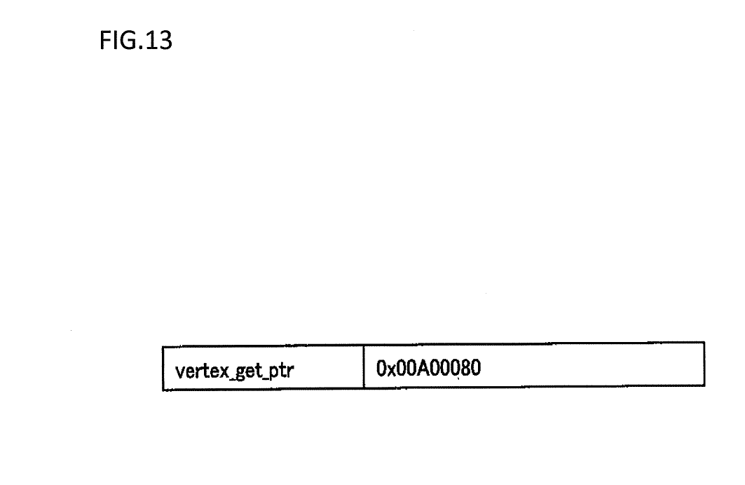

Therefore, “0x00A00080” is stored as the value of the data with the data name “vertex_get_ptr” in the precomputed data 24 (or as part of the graphics drawing control data 23). This is illustrated in FIG. 13.

At step S5 of FIG. 6, the input and output data formats of vertex color data are determined. The determination is made with reference to the input and output data formats of the vertex color data contained in the graphics drawing control data 23. In the exemplary graphics drawing control data 23 in FIG. 7, the input format of the vertex color data indicated by the data with the data name “color_format” is “GDC_TYPE_RGB3X” (the fixed-point data format). In the exemplary graphics drawing control data 23 in FIG. 7, the output format of the vertex command indicated by the data with the data name “DL_format” is “GDC_DL_FORMAT_FLOAT” (the floating-point data format).

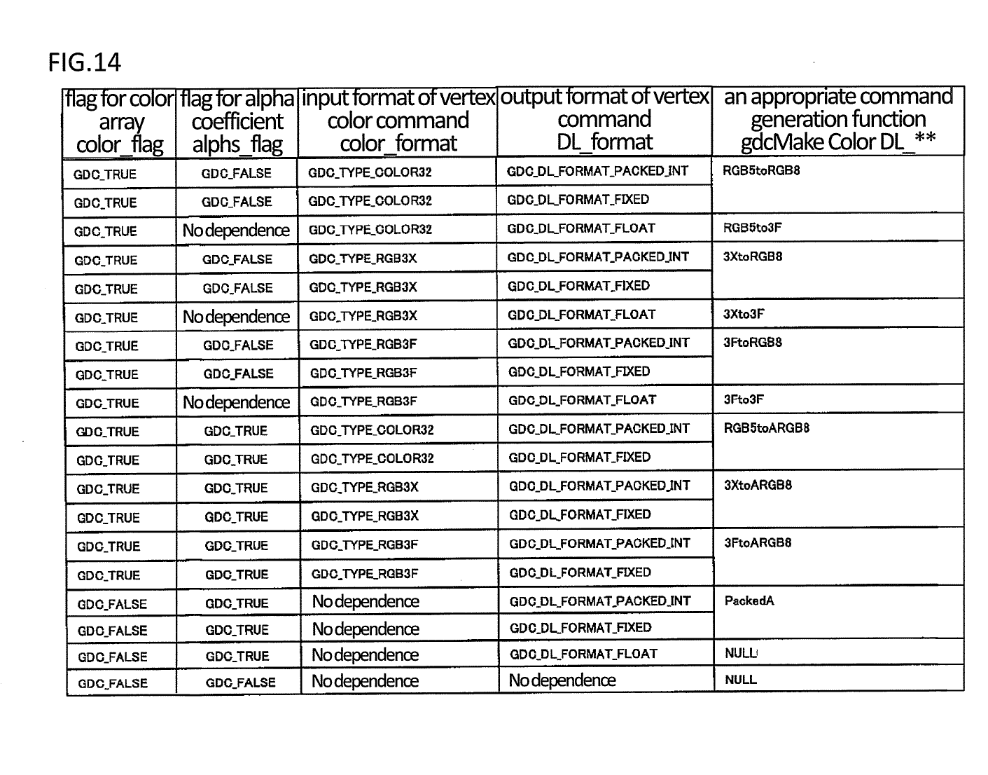

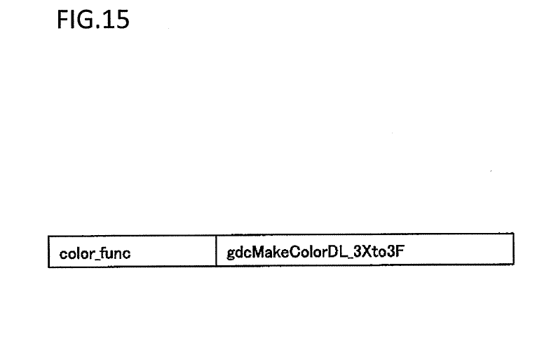

At step S6 of FIG. 6, the most appropriate vertex color command generation function is selected. FIG. 14 is a table illustrating vertex color command generation functions appropriate to combinations of input data formats of vertex color data and output data formats of vertex commands. As illustrated in FIG. 14, appropriate vertex color command generation functions vary depending on a color array flag “color_flag” indicating whether color array is enabled or disabled and an α coefficient flag “alpha_flag” indicating whether alpha blending is enabled or disabled. In the exemplary graphics drawing control data 23 in FIG. 7, the input format of the vertex color data is “GDC_TYPE_RGB3X” and the output format of the vertex command is “GDC_DL_FORMAT_FLOAT” as stated above. Accordingly, the vertex color command generation function appropriate to this combination, that is, the function “gdcMakeColorDL_{—}3Xto3F”, is selected from the table of FIG. 14. Thus, “gdcMakeColorDL_{—}3Xto3F” is stored as the value of the data with the data name “color_func” in the precomputed data 24 (or as part of the graphics drawing control data 23). This is illustrated in FIG. 15.

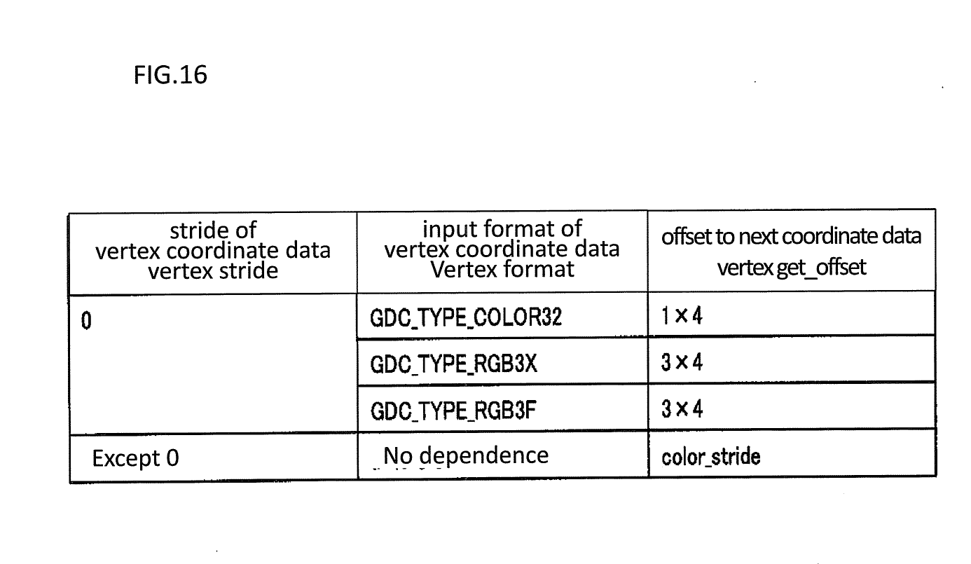

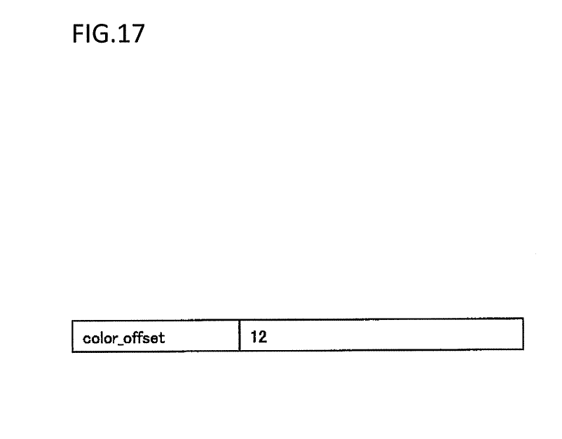

At step S7 of FIG. 6, the offset to the next vertex color data is computed. The offset may be obtained by referring to the value of “color_stride” in the graphics drawing control data 23. In the exemplary graphics drawing control data 23 in FIG. 7, the value of “color_stride” is 0, the meaning of which is given in FIG. 16. When the value of “color_stride” in the graphics drawing control data 23 is 0, the value of the offset to the next vertex color data is determined depending on the input format of the vertex color data as illustrated in FIG. 16. When the value of “color_stride” in the graphics drawing control data 23 is non-zero, the value of “color_stride” is equal to the value of the offset to the next vertex color data regardless of the input format of the vertex color data. Since the value of “color_stride” is 0 and the input format of the vertex color data is “GDC_TYPE_RGB3X” in the exemplary graphics drawing control data 23 in FIG. 7, the offset to the next vertex color data is 3×4. Therefore, 12 is stored as the value of the data with the data name “color_offset” in the precomputed data 24 (or as part of the graphics drawing control data 23). This is illustrated in FIG. 17.

At step S8 of FIG. 6, the address from where the vertex color data is to be obtained is computed. The address “color_first_ptr” from where the vertex color data is to be obtained may be computed according to the following equation.

color_first_{—}ptr=color_{—}ptr+(color_offset×first)

where “color_ptr” and “first” are data defined in the graphics drawing control data 23 and “color_offset” is the offset value obtained at step S7 as described above. In the case of the exemplary graphics drawing control data 23 in FIG. 7,

color_first_{—}ptr=0x00B00000+(12×16)=0x00B000C0

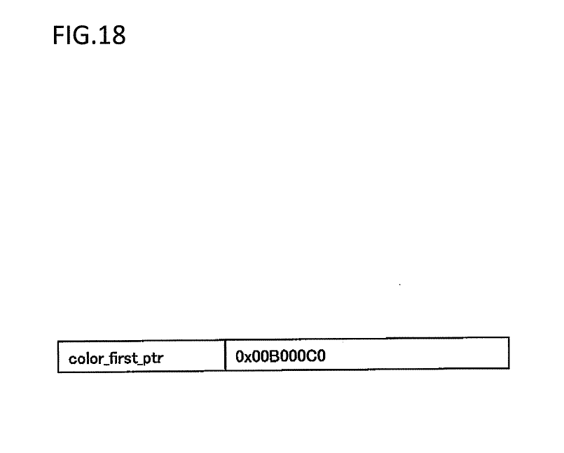

Therefore, “0x00B000C0” is stored as the value of the data with the data name “color_first_ptr” in the precomputed data 24 (or as part of the graphics drawing control data 23). This is illustrated in FIG. 18.

At step S9 of FIG. 6, the input and output data formats of texture coordinate data are determined. The determination is made by referring to data indicating the input and output data formats of texture coordinate data contained in the graphics drawing control data 23. In the exemplary graphics drawing control data 23 in FIG. 7, the input format of the texture coordinate data indicated by the data with the data name “texture_format” is “GDC_TYPE_TEX2XN” (the floating-point data format). In the exemplary graphics drawing control data 23 in FIG. 7, the output format of the vertex command indicated by the data with the data name “DL_format” is “GDC_DL_FORMAT_FLOAT” (the floating-point data format).

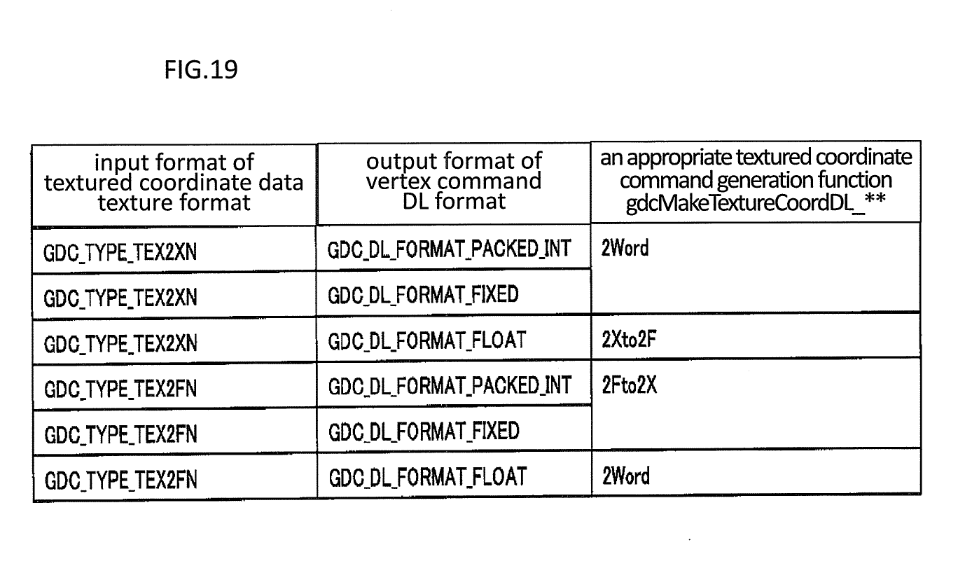

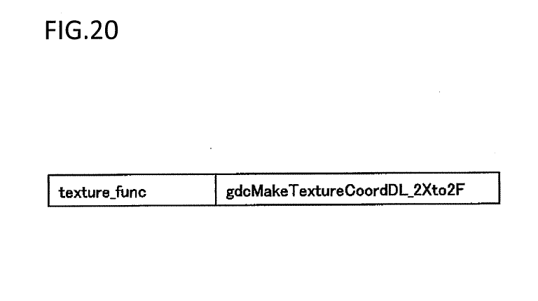

At step S10 of FIG. 6, the most appropriate texture coordinate command generation function is selected. FIG. 19 is a table illustrating texture coordinate command generation functions appropriate to combinations of input data formats of texture coordinate data and output data formats of vertex commands. In the exemplary graphics drawing control data 23 in FIG. 7, the input format of the texture coordinate data is “GDC_TYPE_TEX2XN” and the output format of the vertex command is “GDC_DL_FORMAT_FLOAT” as stated above. Accordingly, the texture coordinate command generation function appropriate to the combination, that is, the function “gdcMakeTextureCoordDL_{—}2Xto2F”, is selected from the table of FIG. 19. Thus, “gdcMakeTextureCoordDL_{—}2Xto2F” is stored as the value of the data with the data name “texture_func” in the precomputed data 24 (or as part of the graphics drawing control data 23). This is illustrated in FIG. 20.

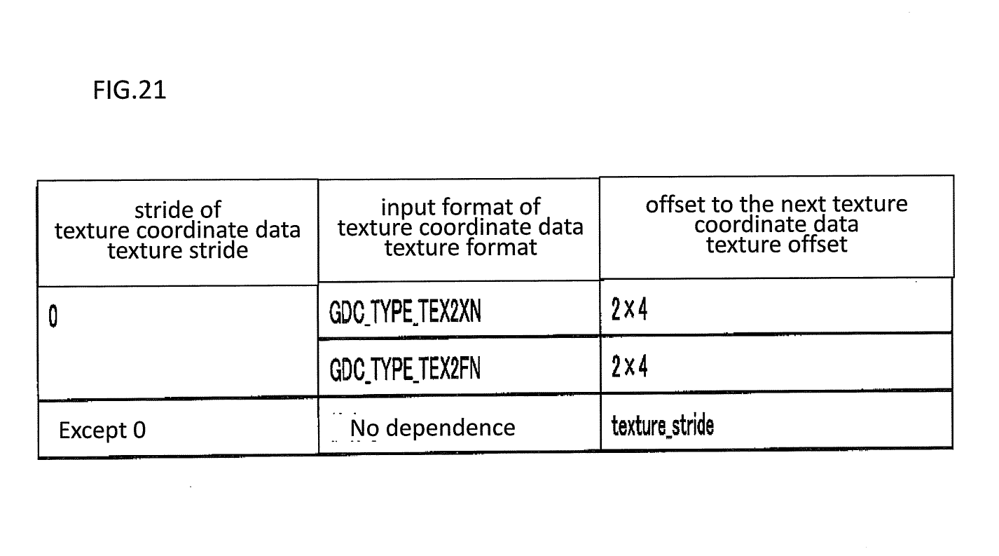

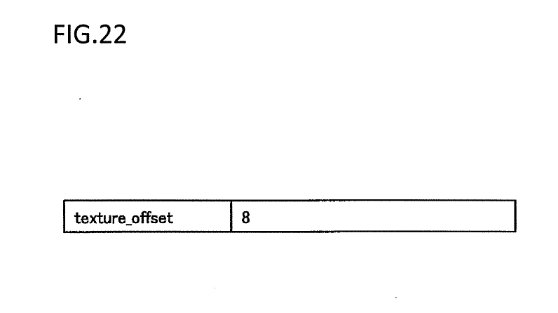

At step S11 of FIG. 6, the offset to the next texture coordinate data is computed. The offset may be obtained by referring to the value of “texture_stride” in the graphics drawing control data 23. In the exemplary graphics drawing control data 23 in FIG. 7, the value of “texture_stride” is 0, the meaning of which is given in FIG. 21. When the value of “texture_stride” in the exemplary graphics drawing control data 23 in FIG. 7 is 0, the offset to the next texture coordinate data is determined depending on the input format of the texture coordinate data as illustrated in FIG. 21. When the value of “texture_stride” in the graphics drawing control data 23 is non-zero, the value of “texture_stride” is the value of the offset to the next texture coordinate data regardless of the input format of the texture coordinate data. Since the value of “texture_stride” is 0 and the input format of the texture coordinate data is “GDC_TYPE_TEXT2XN” in the exemplary graphics drawing control data 23, the offset to the next texture coordinate data is 2×4. Therefore, 8 is stored as the value of the data with the data name “texture_offset” in the precomputed data 24 (or as part of the graphics drawing control data 23). This is illustrated in FIG. 22.

At step S12 of FIG. 6, the address from where texture coordinate data is to be obtained is computed. The address “texture_first_ptr” from where the texture coordinate data is to be obtained may be computed according to the following equation.

texture_first_{—}ptr=texture_{—}ptr+(texture_offset×first)

where “texture_ptr” and “first” are data defined in the graphics drawing control data 23 and “texture_offset” is the offset value obtained at step S11 described above. In the case of the exemplary graphics drawing control data 23 in FIG. 7,

texture_first_{—}ptr=0x00C00000+(8×16)=0x00C000080

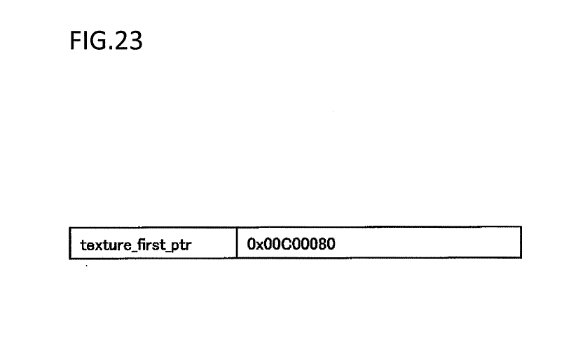

Therefore, “0x00C000080” is stored as the value of the data with the data name “texture_first_ptr” in the precomputed data 24 (or as part of the graphics drawing control data 23). This is illustrated in FIG. 23.

At step S13 of FIG. 6, the output format of the vertex command is determined. The determination is made with reference to the data indicating the output data format of the vertex command contained in the graphics drawing control data 23. In the exemplary graphics drawing control data 23 in FIG. 7, the output format of the vertex command indicated by the data with the data name “DL_format” is “GDC_DL_FORMAT_FLOAT” (the floating-point data format).

At step S14 of FIG. 6, the storage address of the first vertex coordinate command is computed. The storage address “vertex_set_ptr” of the first vertex coordinate command may be computed by adding the sizes of drawing area setting parameters (4 words) and the size of a graphic drawing start command (1 word) to the start address “DL_ptr” of the drawing command storage area. However, if “texture_flag” in the graphics drawing control data 23 is “GDC_TRUE”, a texture image address and width and height setting commands need to be output and therefore the offset equal to the size (6 words) of these commands is also added. In the case of the exemplary graphics drawing control data 23 in FIG. 7,

vertex_set_{—}ptr=0x44000000+((4+1+6)×4)=0x4400002C

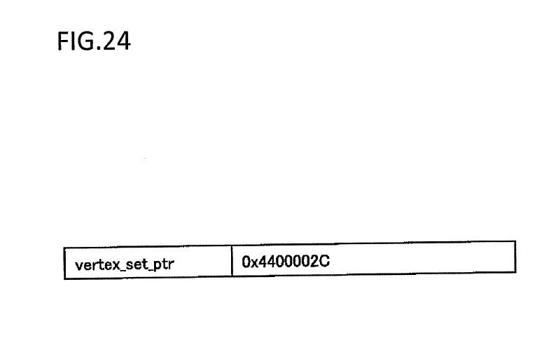

Therefore, “0x4400002C” is stored as the value of data with the data name “vertex_set_ptr” in the precomputed data 24 (or as part of the graphics drawing control data 23). This is illustrated in FIG. 24.

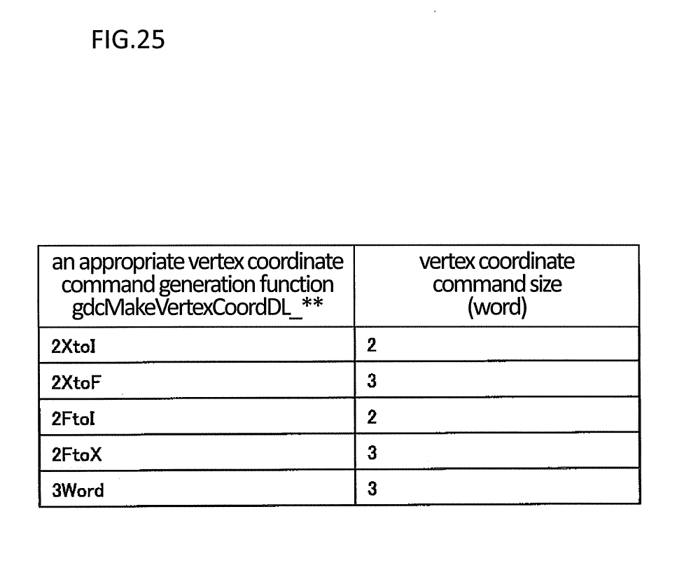

At step S15 of FIG. 6, the storage address of the first vertex color command is computed. The storage address “color_set_ptr” of the first vertex color command may be obtained by adding the vertex coordinate command size that depends on the output data format of the vertex command obtained at step S13 to the storage address of the vertex coordinate command obtained at step S14 described above. FIG. 25 is a table illustrating vertex coordinate command sizes according to vertex coordinate command generation functions. In the exemplary graphics drawing control data 23 in FIG. 7, the output data format is “GDC_DL_FORMAT_FLOAT” (the floating-point data format) and the vertex coordinate command generation function is “gdcMakeVertexCoordDL_{—}2XtoF”. Therefore the vertex command size is 3 words. Thus, in the case of the exemplary graphics drawing control data 23 in FIG. 7,

color_set_{—}ptr=0x4400002C+(3×4)=0x44000038

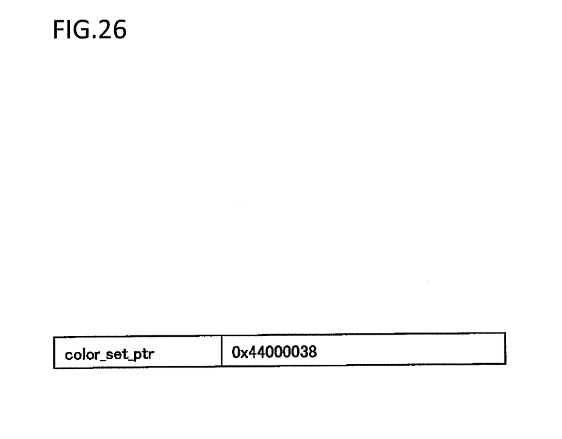

Therefore, “0x44000038” is stored as the value of the data with the data name “color_set_ptr” in the precomputed data 24 (or as part of the graphics drawing control data 23). This is illustrated in FIG. 26.

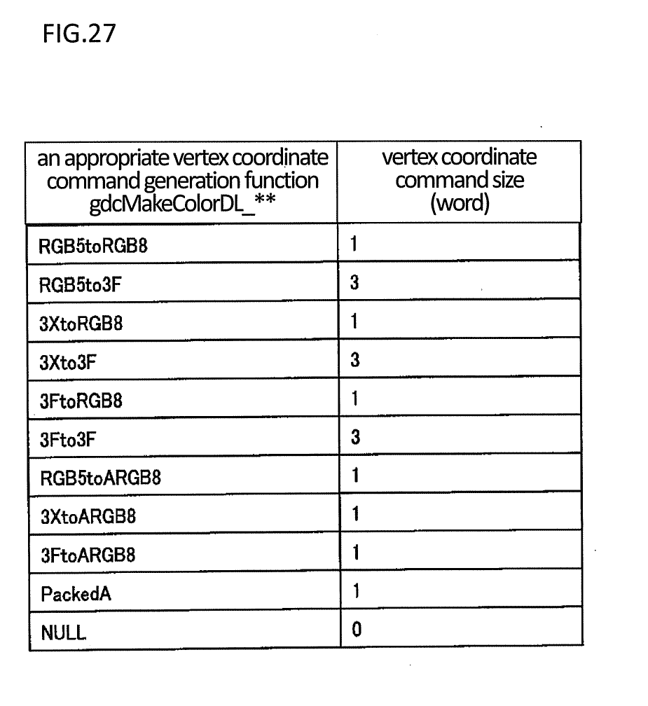

At step S16 of FIG. 6, the storage address of the first texture coordinate command is computed. The storage address “texture_set_ptr” of the first texture coordinate command may be obtained by adding the vertex color command size according to the output data format of the vertex command that has been obtained at step S13 to the vertex color command storage address obtained at step S15 described above. FIG. 27 is a table illustrating vertex color command sizes associated with vertex color command generation functions. In the exemplary graphics drawing control data 23 in FIG. 7, the output data format is “GDC_DL_FORMAT_FLOAT” (the floating-point data format) and the vertex color command generation function is “gdcMakeColorDL_{—}3Xto3F”. Accordingly, the vertex color command size is 3 words. Thus, in the case of the exemplary graphics drawing control data 23 in FIG. 7,

texture_set_{—}ptr=0X44000038+(3×4)=0x44000044

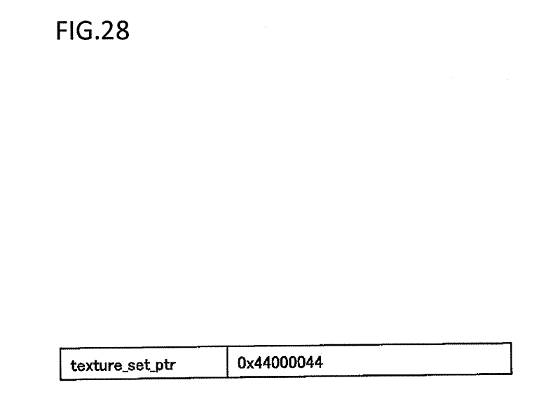

Therefore, “0X44000044” is stored as the value of the data with the data name “texture_set_ptr” in the precomputed data 24 (or as part of graphics drawing control data 23). This is illustrated in FIG. 28.

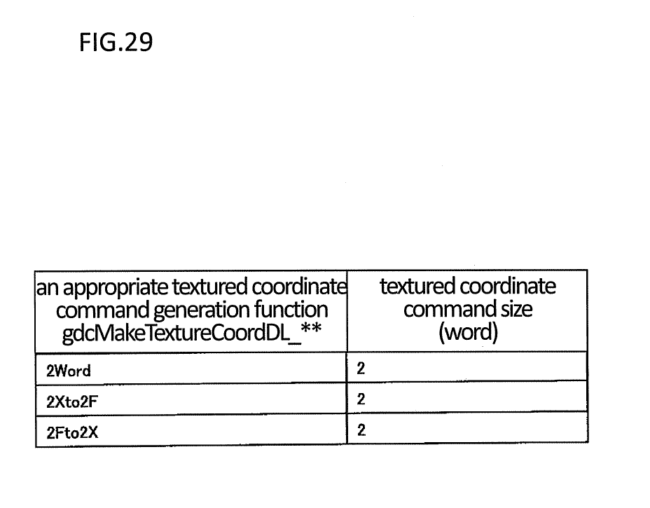

At step S17 of FIG. 6, the offset to the next vertex command storage address is computed. The offset to the next vertex command storage address “vertex_set_offset” is equal to the sum of the size of the vertex coordinate command, the size of the vertex color command, and the size of the texture coordinate command. FIG. 29 is a table illustrating texture coordinate command sizes associated with the texture coordinate command generation functions. In the exemplary graphics drawing control data 23 in FIG. 7, the texture coordinate command generation function is “gdcMakeTextureCoordDL_{—}2Xto2F”. Therefore, as seen from the table, the texture coordinate command size is 2 words. Thus, in the case of the exemplary graphics drawing control data 23 in FIG. 7,

vertex_set_offset=(3+3+2)×4=32

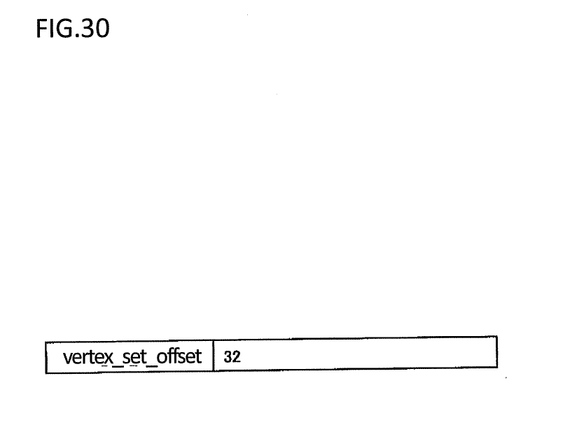

Therefore, 32 is stored as the value of the data with the data name “vertex_set_offset” in the precomputed data 24 (or as part of the graphics drawing control data 23). This is illustrated in FIG. 30.

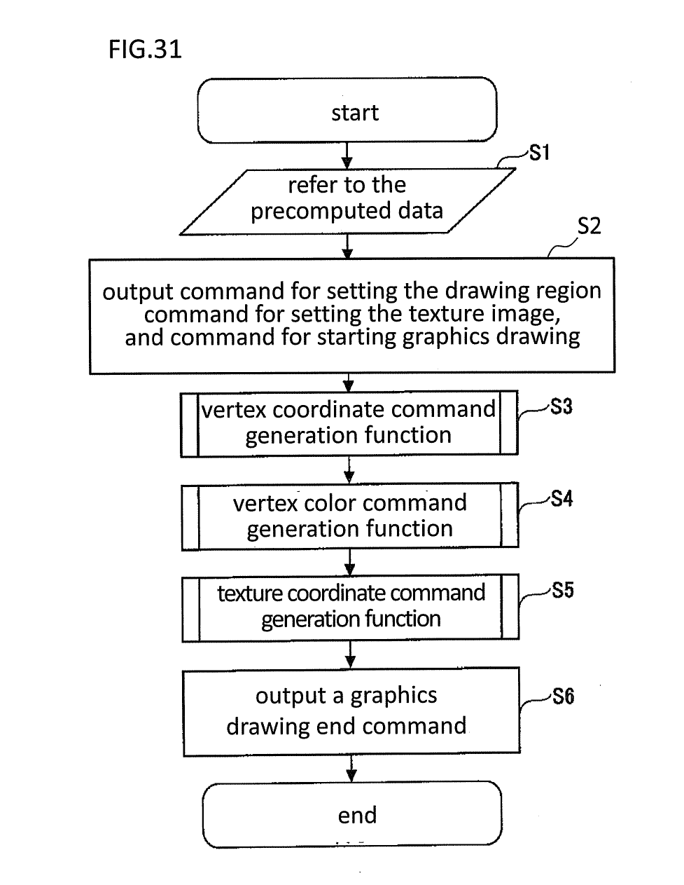

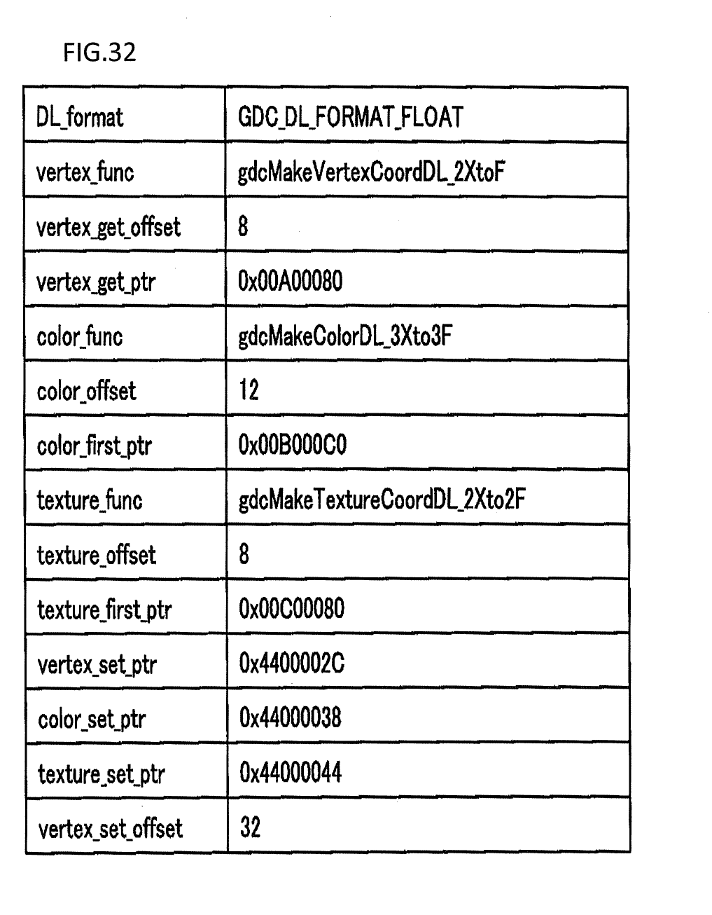

FIG. 31 is a flowchart illustrating details of the graphics drawing data generation process at step S3 of FIG. 5. The steps of FIG. 31 are performed by the CPU 10 in FIG. 1. At step S1, the CPU 10 refers to the precomputed data 24 (which may be part of the graphics drawing control data 23). FIG. 32 illustrates the precomputed data 24 computed from the exemplary graphics drawing control data 23 in FIG. 7. For convenience, “DL_format” is also illustrated as part of the precomputed data 24. The CPU 10 refers to other data in the graphics drawing control data 23 in addition to the precomputed data 24 as will be described below.

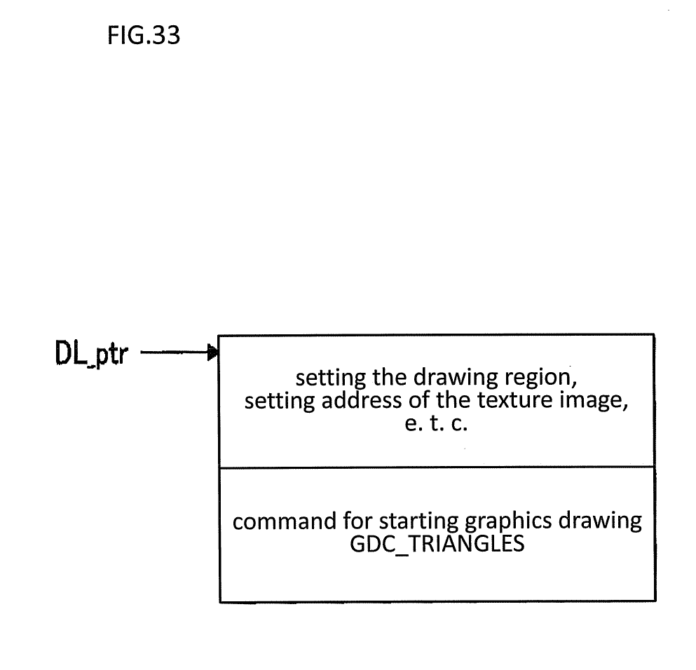

At step S2 of FIG. 31, the CPU 10 outputs commands and stores the commands in the VRAM 16 (see FIG. 1). In particular, the CPU 10 refers to “draw_ptr” and “draw_stride” in the graphics drawing control data 23, reads commands that set a drawing area and stores the commands from the address in the VRAM 16 indicated by “DL_ptr”. Here, “draw_ptr” is the address indicating the upper left corner of a rectangular drawing area and “draw_stirde” is data indicating the stride of the drawing area (the horizontal length of the rectangular drawing area). If “texture_flag” is enabled, the CPU 10 refers to “image_ptr”, “image_width” and “image_height” in the graphics drawing control data 23, generates a texture image setting command, and stores the command after the commands that set the drawing area. Lastly, the CPU 10 generates and stores a graphics drawing start command “GDC_TRIANGLES”. FIG. 33 illustrates how various setting commands and a graphics drawing start command are stored from the address indicated by DL_ptr in a VRAM memory space.

At step S3 of FIG. 31, the CPU 10 calls a vertex coordinate command generation function specified in the precomputed data 24. Since the vertex coordinate command generation function “gdcMakeVertexCoordDL_{—}2XtoF” is specified in the exemplary precomputed data 24 in FIG. 32, the vertex coordinate command generation function is called. Then, at step S4 of FIG. 31, the CPU 10 calls a vertex color command generation function specified in the precomputed data 24. Since the vertex color command generation function “gdcMakeColorDL_{—}3Xto3F” is specified in the exemplary precomputed data 24 in FIG. 32, the vertex color command generation function is called. Then, at step S5 of FIG. 31, the CPU 10 calls a texture coordinate command generation function specified in the precomputed data 24. Since the texture coordinate command generation function “gdcMakeTextureCoordDL_{—}2Xto2F” is specified in the exemplary precomputed data 24 in FIG. 32, the texture coordinate command generation function is called. Lastly, at step S6, the CPU 10 outputs a graphics drawing end command. That is, data indicating the end of the graphics drawing is placed at the end of the series of vertex commands in the graphics data 22 in the VRAM 16.

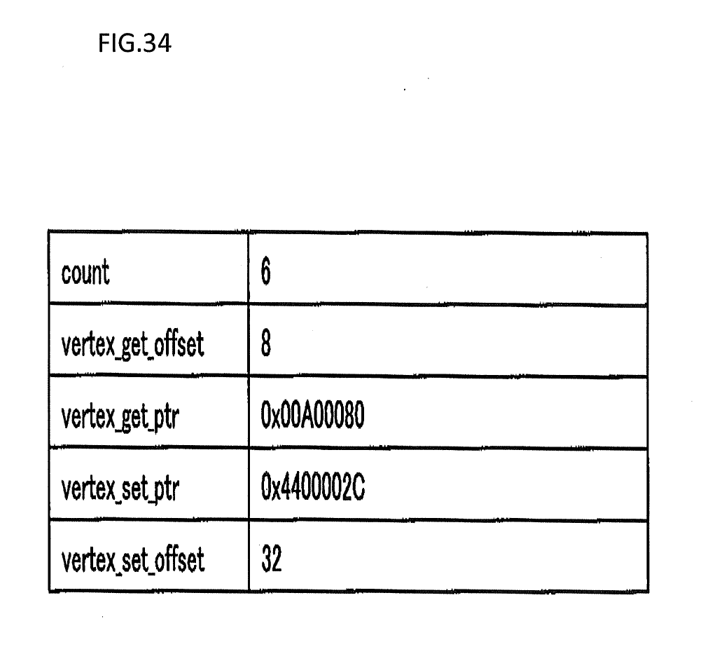

FIG. 34 illustrates arguments used in calling the vertex coordinate command generation function for the exemplary precomputed data 24 illustrated in FIG. 32. In calling the vertex coordinate command generation function at step S3 of FIG. 31, data values illustrated in FIG. 34 are specified in arguments of the function as parameters for controlling the command generation.

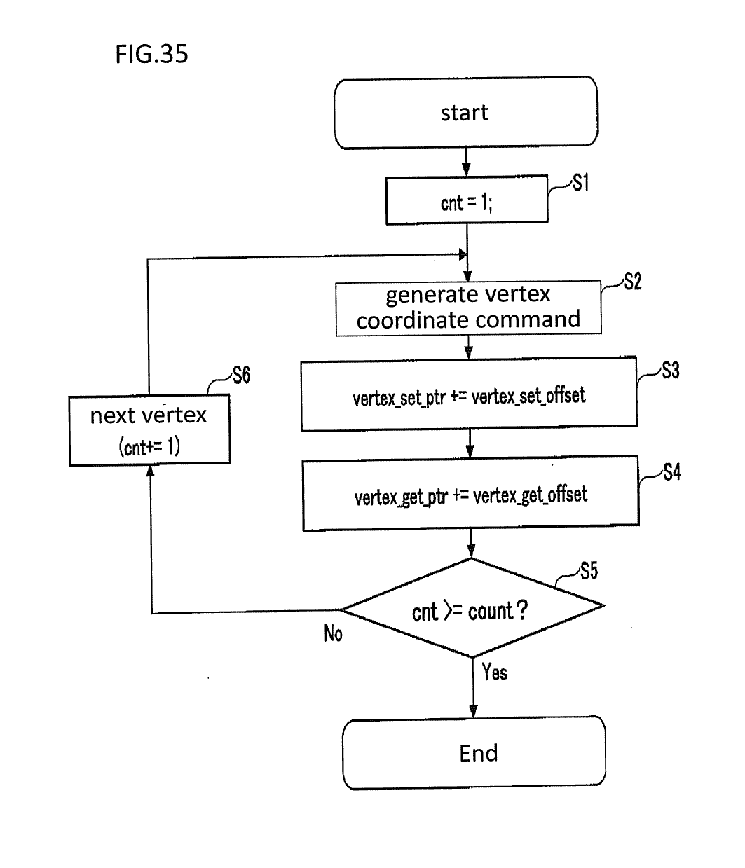

FIG. 35 is a flowchart illustrating details of the vertex coordinate command generation process by the vertex coordinate command generation function. The steps of FIG. 35 are performed by the CPU 10. At step S1, a vertex count “cnt” is initialized to 1. At step S2, a vertex coordinate command is generated. For the exemplary precomputed data 24 in FIG. 32, vertex coordinates data X and Y in the fixed-point data format read from “vertex_get_ptr” are converted to the floating-point data format. A vertex command with a fixed value (the G_Vertex command in FIG. 2) is added to the converted vertex coordinate data X and Y and the data and the command are stored in the vertex coordinate command storage location “vertex_set_ptr”. At step S3, the offset “vertex_set_offset” to the next vertex command storage address is added to the storage address “vertex_set_ptr” of the current vertex coordinate command to obtain the storage address of a new vertex coordinate command. At step S4, the offset “vertex_get_offset” to the next vertex coordinate data is added to the address “vertex_get_ptr” from where the current vertex coordinate data has been obtained to obtain the address from where new vertex coordinate data is to be obtained. At step S5, determination is made as to whether the vertex count “cnt” is greater than or equal to the number of vertices “count” to be drawn. If the vertex count “cnt” is smaller than the number of vertices “count”, the vertex count “cnt” is incremented by 1 at step S6, then the process returns to step S2 and the step S2 and the subsequent steps are repeated. As a result of the process described above and illustrated in FIG. 35, the vertex coordinate command section of the graphics drawing data 20 is generated from the vertex coordinate data in the graphics data 22.

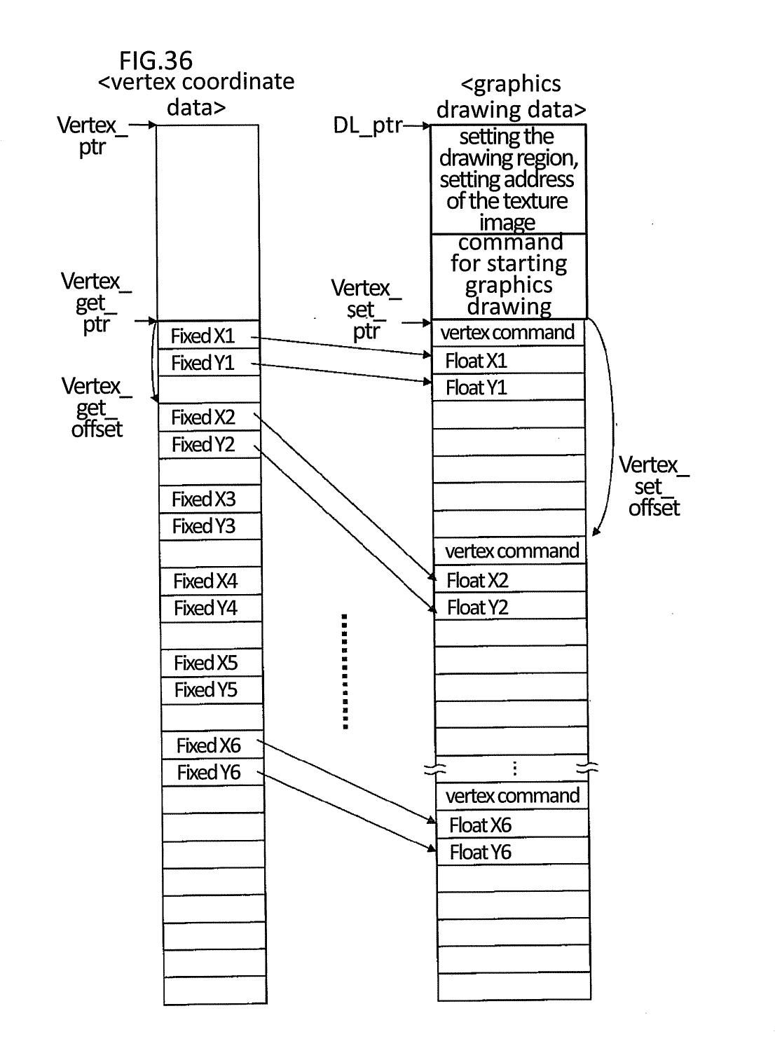

FIG. 36 schematically illustrates the vertex coordinate command generation process by the vertex coordinate command generation function. The position of the n-th vertex (the vertex data number indicated by “first”) from the start address “vertex_ptr” of the vertex coordinate data is indicated by “vertex_get_ptr”. Starting at “vertex_get_ptr”, fixed-point format data X (fixed X1 through X6) and Y (fixed Y1 through Y6) arranged at intervals of “vertex_get_offset” are read out and converted to floating-point format data X (float X1 through X6) and Y (float Y1 through Y6). The converted floating-point format data X and Y are stored in the VRAM 16 at intervals of “vertex_set_offset”, starting at “vertex_set_ptr”.

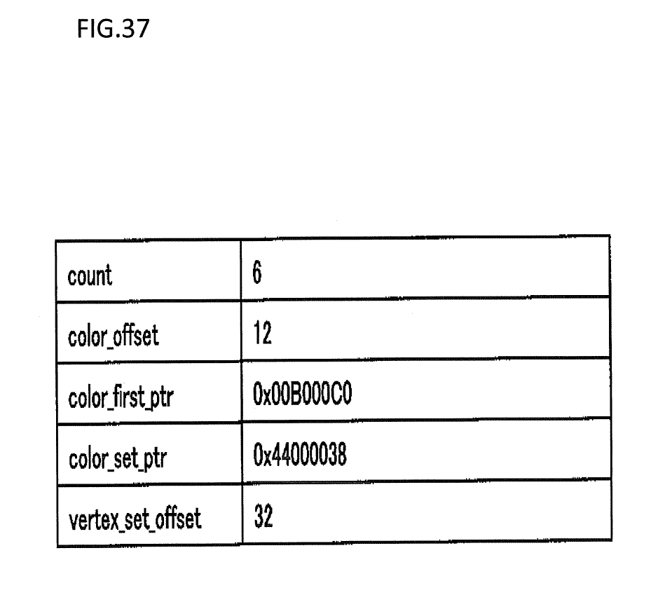

FIG. 37 illustrates arguments used in calling the vertex color command generation function for the exemplary precomputed data 24 in FIG. 32. In calling the vertex color command generation function at step S4 of FIG. 31, data values illustrated in FIG. 37 are specified in arguments of the function as parameters for controlling the command generation process.

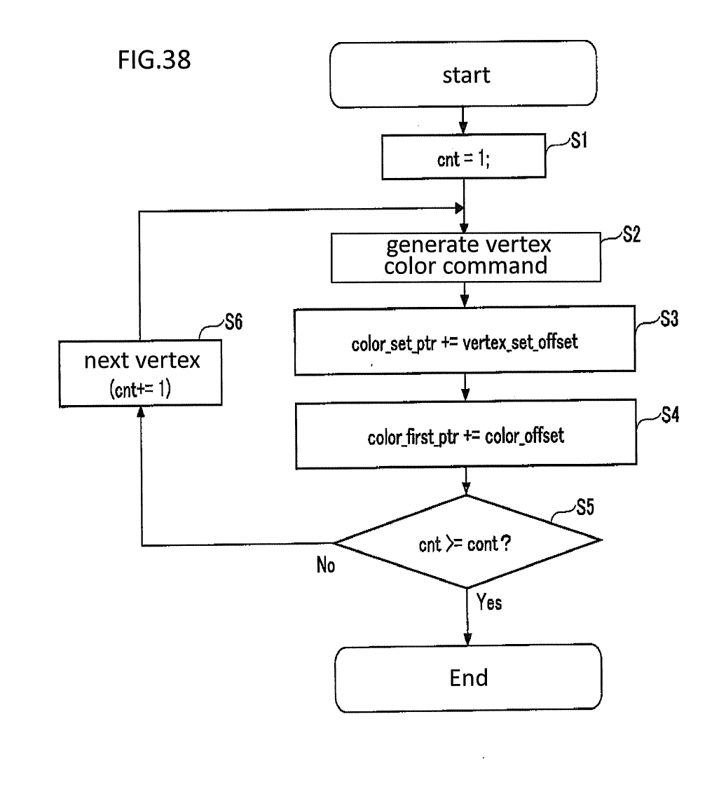

FIG. 38 is a flowchart illustrating details of the vertex color command generation by the vertex color command generation function. The steps in FIG. 38 are performed by the CPU 10. At step S1, the vertex count “cnt” is initialized to 1. At step S2, a vertex color command is generated. For the exemplary precomputed data 24 in FIG. 32, fixed-point format vertex color data RGB read from “color_first_ptr” are converted to the floating-point format. The converted vertex color data RGB are stored in the vertex color command storage location “color_set_ptr”. At step S3, the offset “vertex_set_offset” to the next vertex command storage address is added to the current vertex color command storage address “color_set_ptr” to obtain a new vertex color command storage address. At step S4, the offset “color_offset” to the next vertex color data is added to the address “color_first_ptr” from where the current vertex color data has been obtained to obtain the address from where new vertex color data is to be obtained. At step S5, determination is made as to whether the vertex count “cnt” is greater than or equal to the number of vertices “count” to be drawn. If the vertex count “cnt” is smaller than the number of vertices “count” to be drawn, the vertex count “cnt” is incremented by 1 at step S6, then the process returns to step S2 and the step S2 and the subsequent steps are repeated. As a result of the process described above and illustrated in FIG. 38, the vertex color command section of the graphics drawing data 20 is generated from the vertex color data in the graphics data 22.

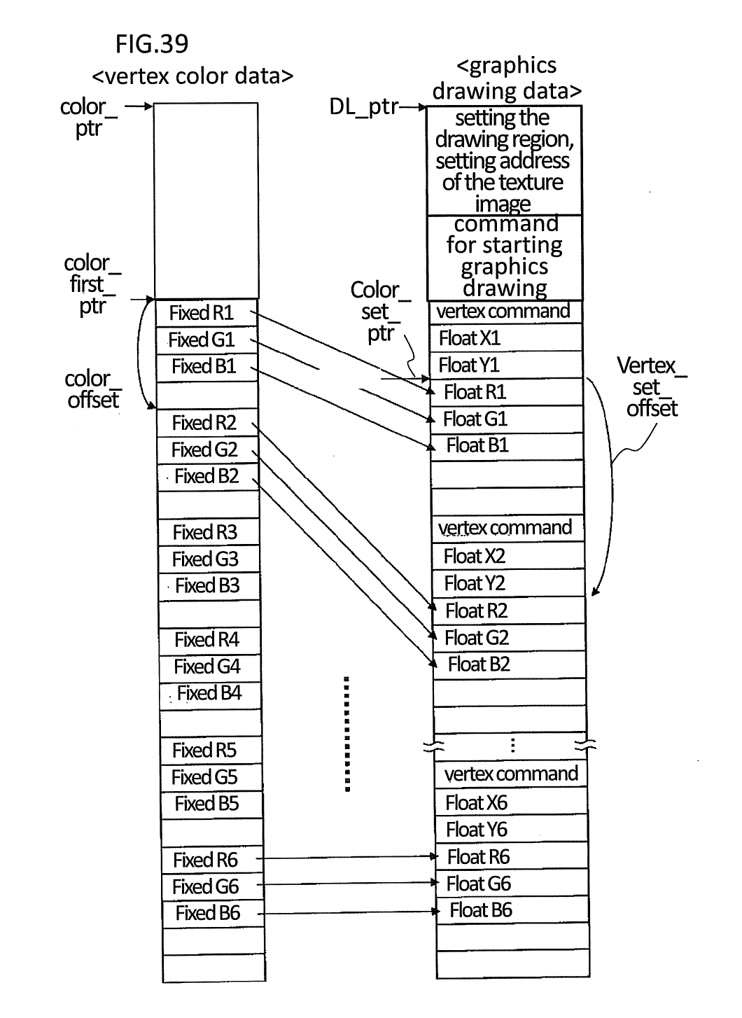

FIG. 39 schematically illustrates vertex color command generation process by the vertex color command generation function. The position of the n-th vertex (a vertex data number indicated by “first”) from the start address “color_ptr” of the vertex color data is indicated by “color_first_ptr”. Starting at “color_first_ptr”, fixed-point format data R (fixed R1 through R6), G (fixed G1 through G6), and B (fixed B1 through B6) arranged at intervals of “color_offset” are read out and converted to floating-point format data RGB. The converted floating-point format data R (float R1 through R6), G (float G1 through G6), and B (float B1 through B6) are stored in the VRAM 16 at intervals of “vertex_set_offset”, starting at “color_set_ptr”.

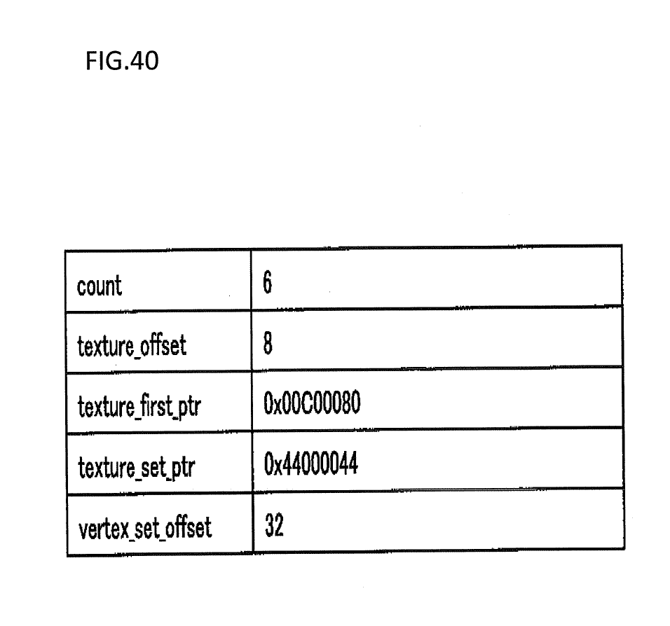

FIG. 40 illustrates arguments used in calling the texture coordinate command generation function for the exemplary precomputed data 24 in FIG. 32. In calling the texture coordinate command generation function at step S5 of FIG. 31, data values illustrated in FIG. 40 are specified in arguments of the function as parameters for controlling the command generation.

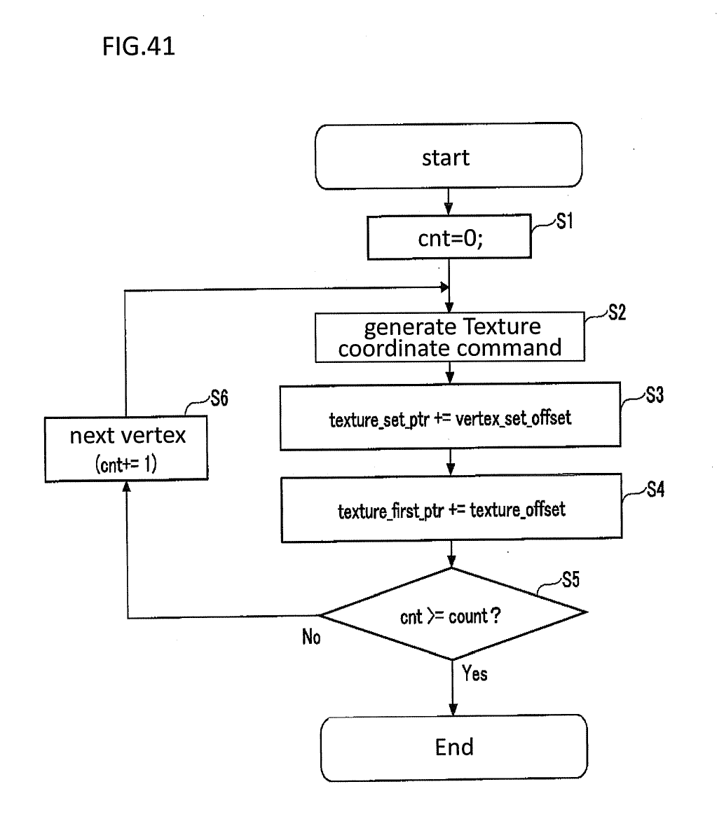

FIG. 41 is a flowchart illustrating the texture coordinate command generation process by the texture coordinate command generation function. The steps in FIG. 41 are performed by the CPU 10. At step Si, the vertex count “cnt” is initialized to 1. At step S2, a texture coordinate command is generated. For the exemplary precomputed data 24 in FIG. 32, fixed-point format texture coordinate data X and Y read from “texture_first_ptr” are converted to the floating-point format. The converted texture coordinate data X and Y are stored in the texture coordinate command storage location “texture_set_ptr”. At step S3, the offset “vertex_set_offset” to the next vertex command storage address is added to the current texture coordinate command storage address “texture_set_ptr” to obtain a new texture coordinate command storage address. At step S4, the offset “texture_offset” to the next texture coordinate data is added to the address “texture_first_ptr” from where the current texture coordinate data has been obtained to obtain the address from where new texture coordinate data is to be obtained. At step S5, determination is made as to whether the vertex count “cnt” is greater than or equal to the number of vertices “count” to be drawn. If the vertex count “cnt” is smaller than the number of vertices “count” to be drawn, the vertex count “cnt” is incremented by 1 at step S6, then the process returns to step S2 and the step S2 and the subsequent steps are repeated. As a result of the process described above and illustrated in FIG. 41, the texture coordinate command section of the graphics drawing data 20 is generated from the texture coordinate data in the graphics data 22.

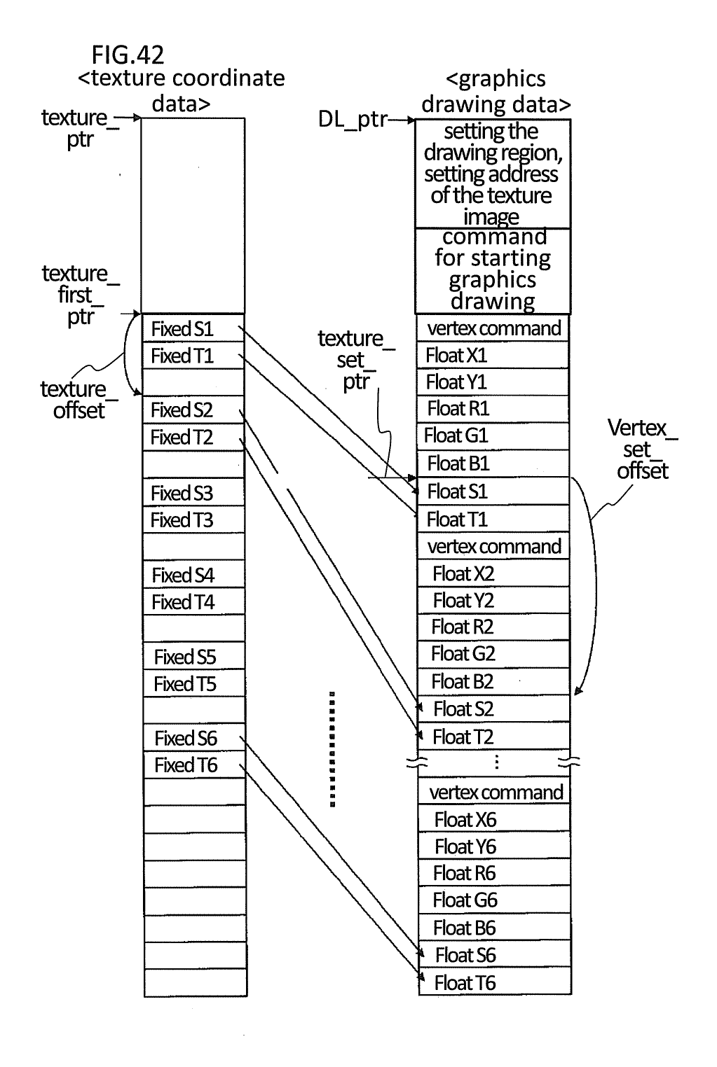

FIG. 42 schematically illustrates the texture coordinate command generation by the texture coordinate command generation function. The position of the n-th vertex (the vertex data number indicated by “first”) from the start address “textire_ptr” of the texture coordinate data is indicated by “texture_first_ptr”. Starting at “texture_first_ptr”, fixed-point format data S (fixed S1 through S6) and T (fixed T1 through T6) arranged at intervals of “textrue_offset” are read out and converted to floating-point format data S (float S1 through S6) and T (float T1 through T6). The converted floating-point format data S and T are stored in the VRAM 16 at intervals of “vertex_set_offset”, starting at “texture_set_ptr”. Here, S and T represent a pair of coordinates of the texture image.

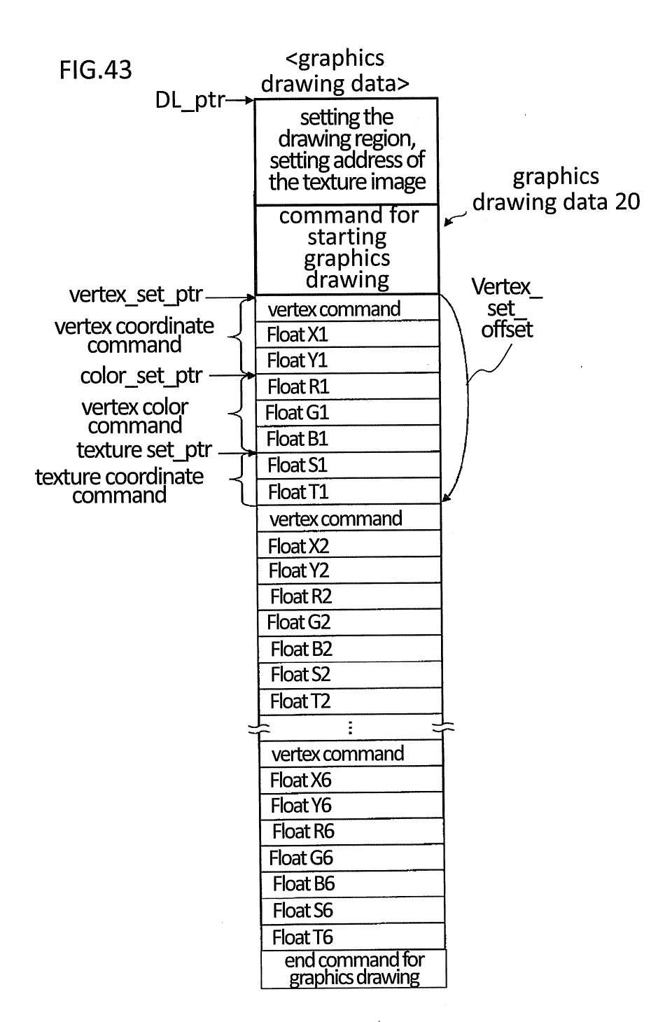

FIG. 43 illustrates a structure of graphics drawing data 20 generated in a memory space of the VRAM 16 as a result of the process described above. Data concerning the vertex coordinate commands represented in the floating-point format, the vertex color commands represented in the floating-point format, and the texture coordinate commands represented in the floating-point format for multiple vertices (6 vertices in the example) are arranged in the structure. A graphics drawing end command is located at the end of the graphics drawing data 20.

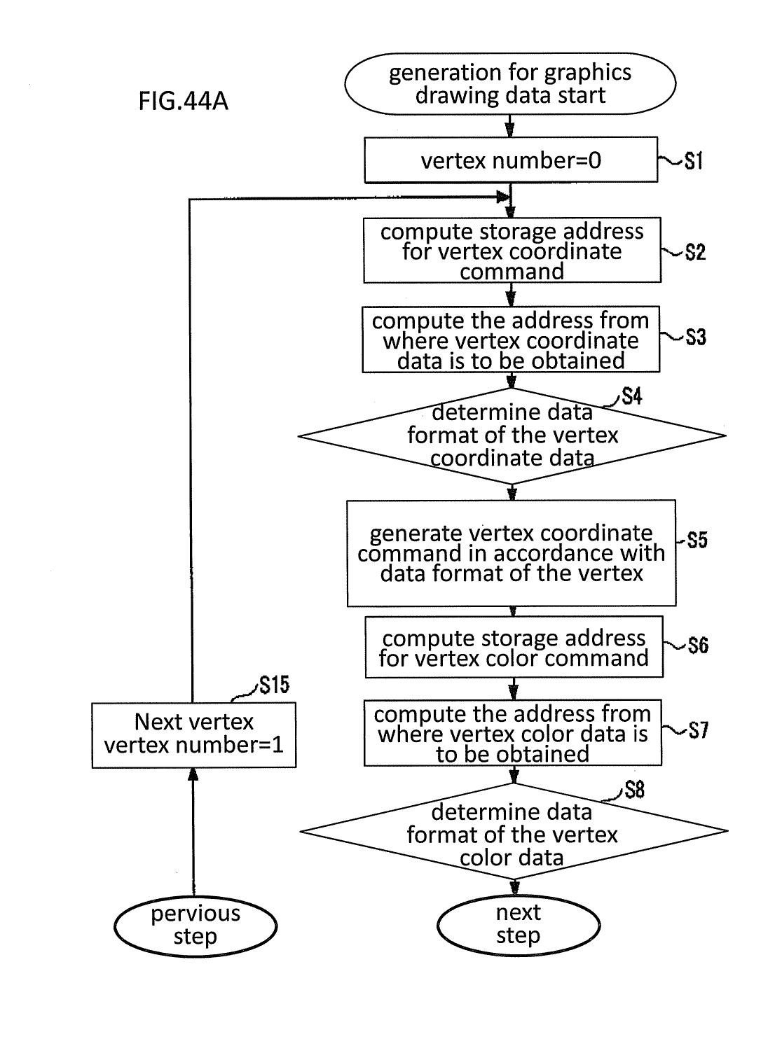

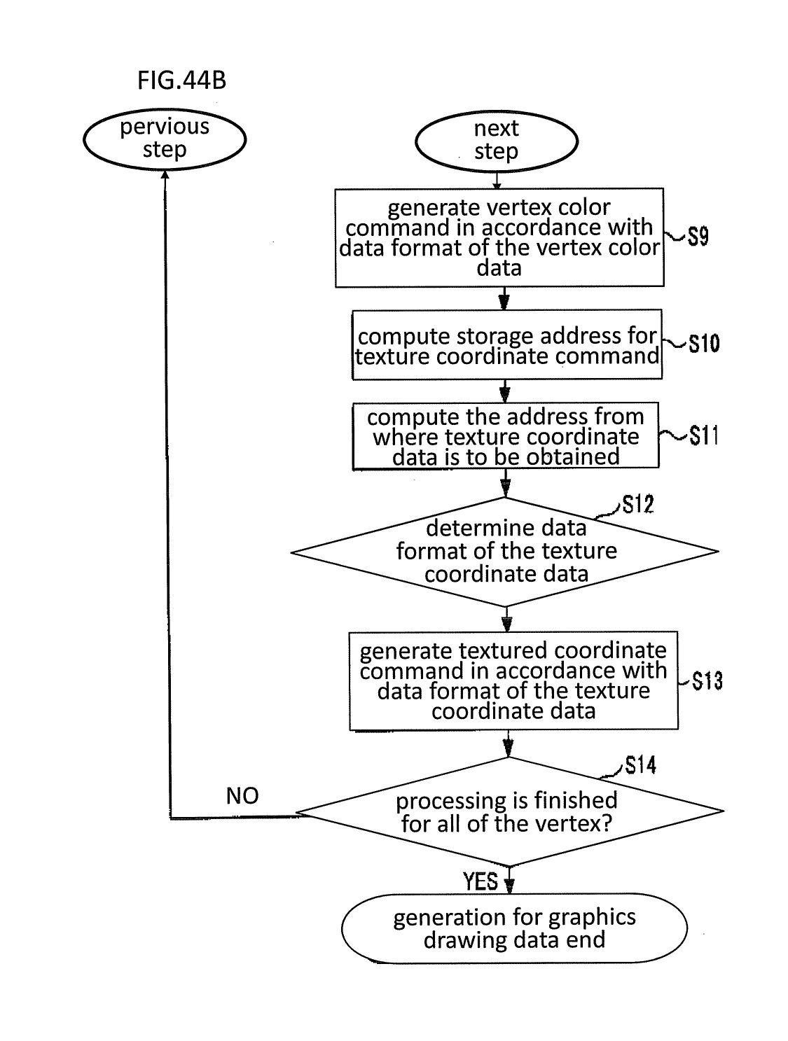

FIGS. 44A and 44B are a flowchart illustrating a conventional graphics drawing data generation process. At step S1, a vertex number is initialized. Steps S2 through S5 are the section of the process that is related to vertex coordinate data, where a vertex coordinate command storage address and an address from where vertex coordinate data is to be obtained are computed, the input and output data formats of the vertex coordinate data are determined, and a vertex coordinate command is generated. Steps S6 through S9 are the section of the process that is related to vertex color data, where a vertex color command storage address and an address from where vertex color data is to be obtained are computed, the input and output formats of the vertex color data are determined, and a vertex color command is generated. Steps S10 through S13 are the section of the process that is related to texture coordinate data, where a texture coordinate command storage address and an address from where texture coordinate data is to be obtained are computed, the input and output formats of the texture coordinate data are determined, and a texture coordinate command is generated. At step S14, determination is made as to whether the process has been performed on all vertices. If there is an additional vertex to be processed, the process proceeds to the next vertex at step S15, then returns to step S2 and step S2 and the subsequent steps are repeated. Since the determination of the data formats and computations of the addresses are performed on a vertex-by-vertex basis in this way, the conventional graphics drawing data generation process is inefficient.

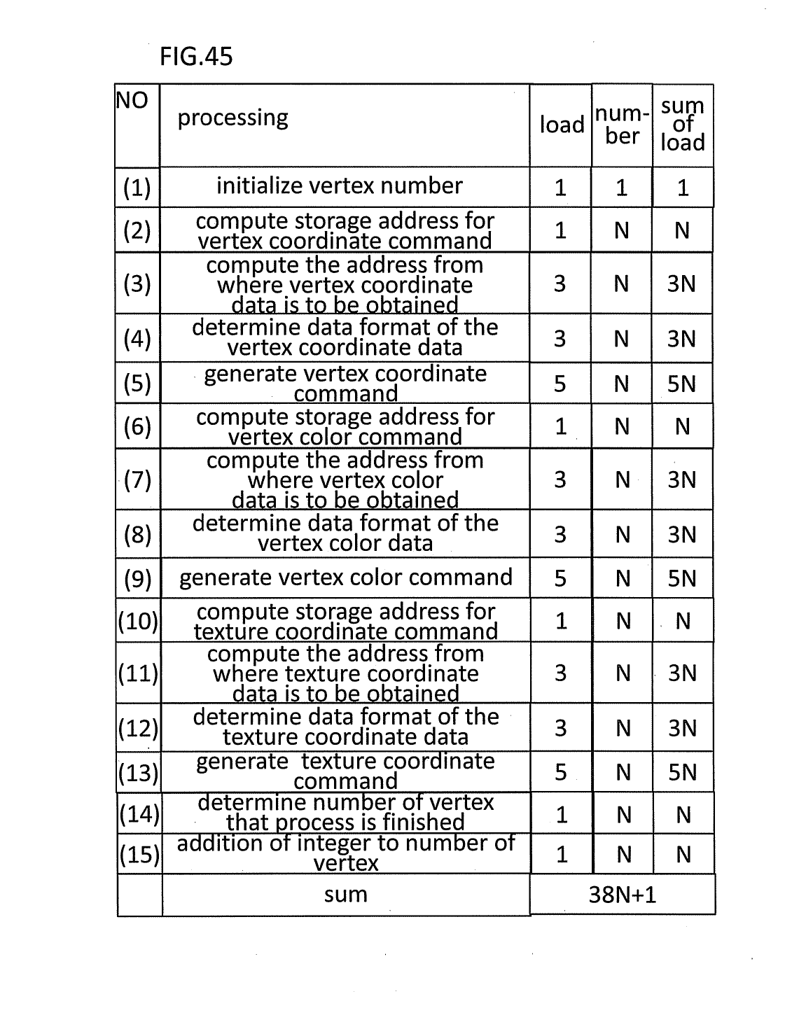

FIG. 45 is a table illustrating processing loads in the conventional graphics drawing data generation process illustrated in FIGS. 44A and 44B. Here, N represents the number of vertices to be drawn. The processing loads of the operations are relative value on the basis of integer addition=1. As may be seen from FIG. 45, a processing load of 38N+1 in total is placed on the CPU 10 in the conventional graphics drawing data generation process illustrated in FIGS. 44A and 44B, where N is the number of vertices to be drawn.

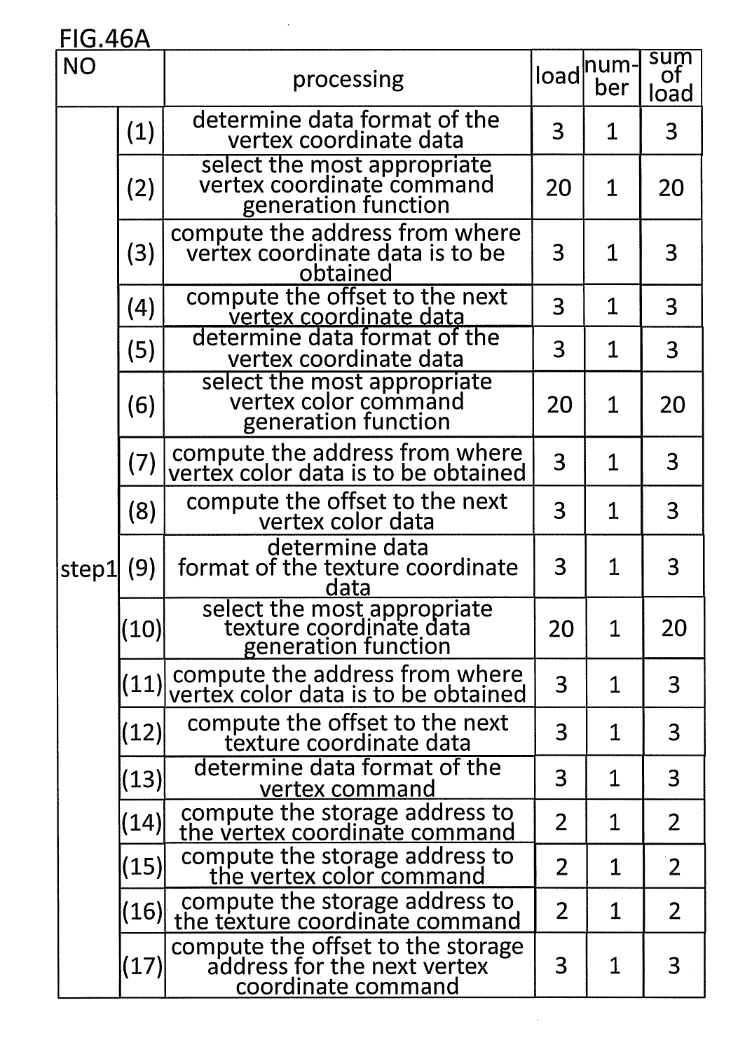

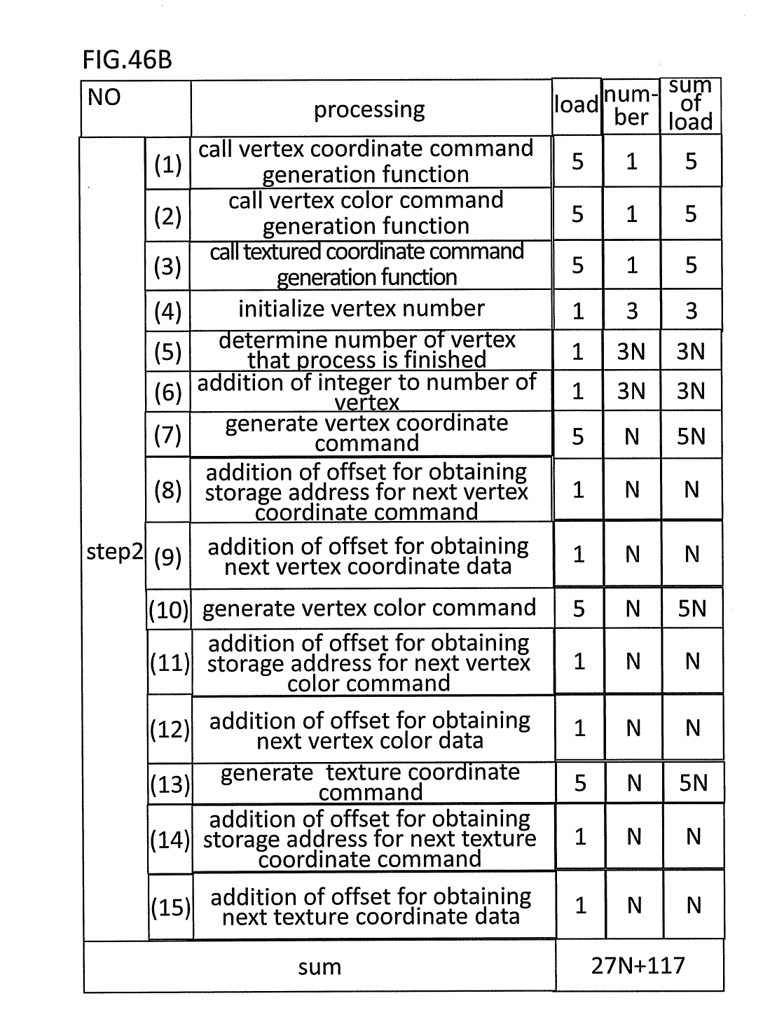

FIGS. 46A and 46B are a table illustrating processing loads in the graphics drawing data generation process, at steps S2 and S3 of FIG. 5. As may be seen from FIGS. 46A and 46B, a processing load of 27N+117 in total is placed on the CPU 10 in the graphics drawing data generation process according to the present exemplary embodiment illustrated in FIG. 5, where N is the number of vertices to be drawn. If the number N of vertices to be drawn is large, the graphics drawing data generation process according to the exemplary embodiment is advantageous since the processing load is significantly smaller than that of the conventional process. Specifically, the processing load may be reduced by approximately 30% compared with the conventional process.

However, if the number of vertices is small, the processing load of the graphics drawing data generation process according to the present exemplary embodiment may be greater than that of the conventional graphics drawing data generation process because of the processing load of the pre-processing at step S2 of FIG. 5. To address this problem, switching may be made between the graphics drawing data generation process of the present exemplary embodiment and the conventional graphics drawing data generation process according to the number of vertices.

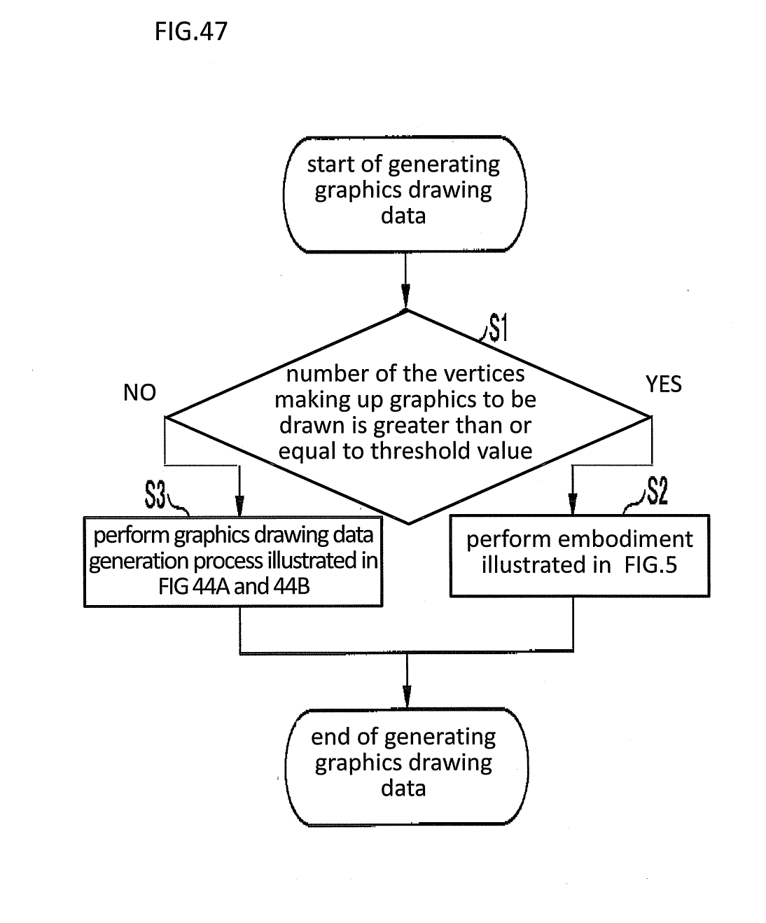

FIG. 47 is a flowchart illustrating a process according to an exemplary embodiment in which switching is made between the two graphics drawing processes. At step S1, determination is made as to whether the number of the vertices making up graphics to be drawn is greater than or equal to a threshold value. If the number of the vertices is greater than or equal to the threshold value, the graphics drawing data generation process of the present exemplary embodiment illustrated in FIG. 5 is performed at step 2; otherwise, the conventional graphics drawing data generation process illustrated in FIGS. 44A and 44B are performed at step S3.

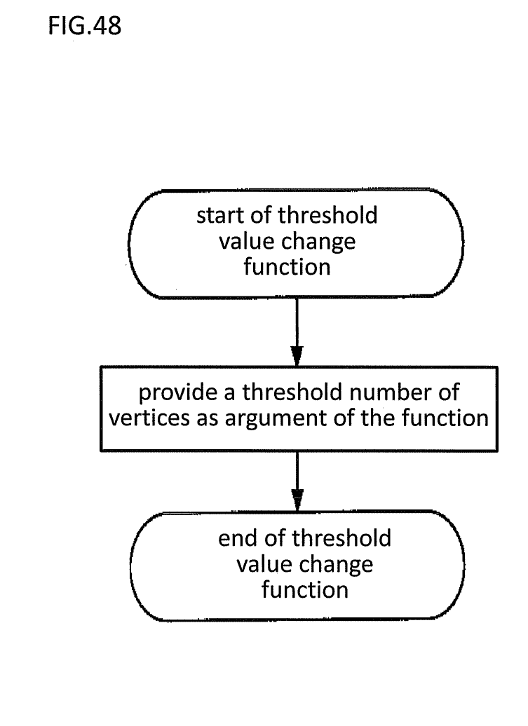

FIG. 48 is a flowchart of a process for setting the threshold value used in the determination at step S1 of FIG. 47. In the process of the flowchart, a threshold value change function is called and a threshold number of vertices is provided as an argument of the function. With this, the threshold value is set to the number provided as the argument. Since the threshold value in practice varies depending on hardware such as the CPU and memory, it is preferable to set the threshold value for each system by using such threshold value change function (threshold value setting function). An appropriate threshold value may be identified for example by performing both of the conventional graphics drawing data generation process and the graphics drawing data generation process of the present exemplary embodiment to generate graphics drawing data from multiple pieces of test graphics data containing different numbers of vertices and measuring the processing time and loads of both processes.

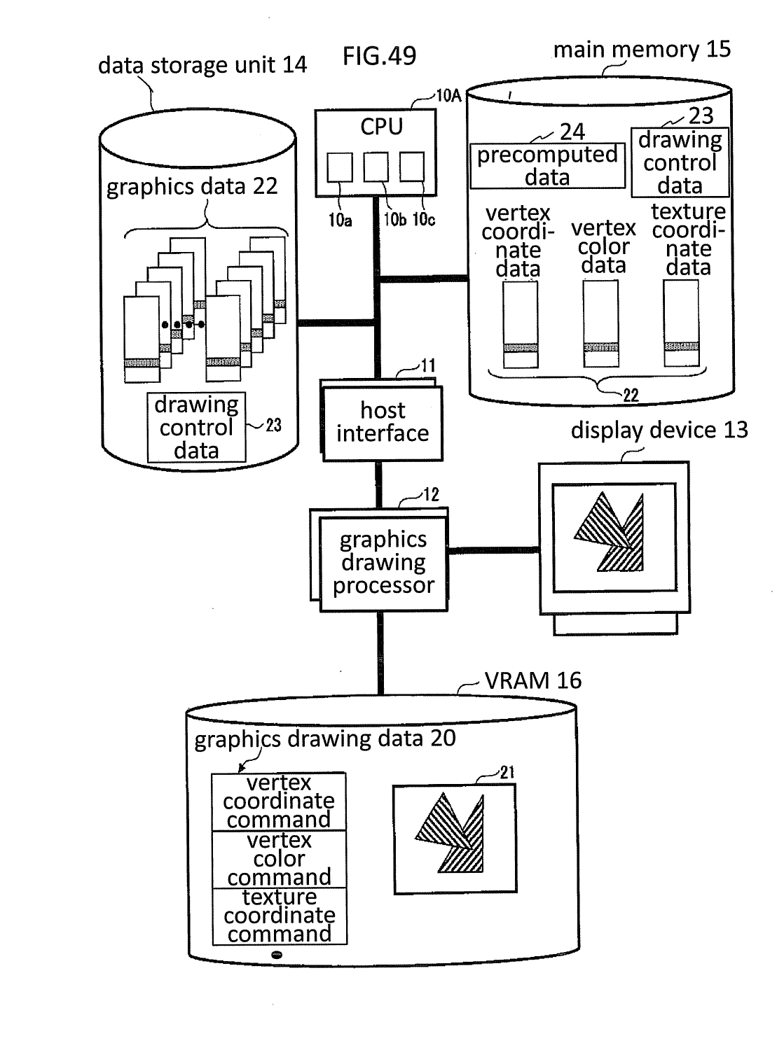

FIG. 49 illustrates a variation of the graphics drawing system. The graphics drawing system illustrated in FIG. 49 includes a central processing unit (CPU) 10A, a host interface 11, a graphics drawing processor 12, a display device 13, a data storage unit 14, a main memory 15, and a video random access memory (VRAM) 16. The graphics drawing system differs from the graphics drawing system in FIG. 1 in that the CPU 10A includes multiple cores 10a, 10b and 10c. The cores 10a, 10b and 10c perform the vertex coordinate command generation process, the vertex color command generation process and the texture coordinate command generation process in parallel.

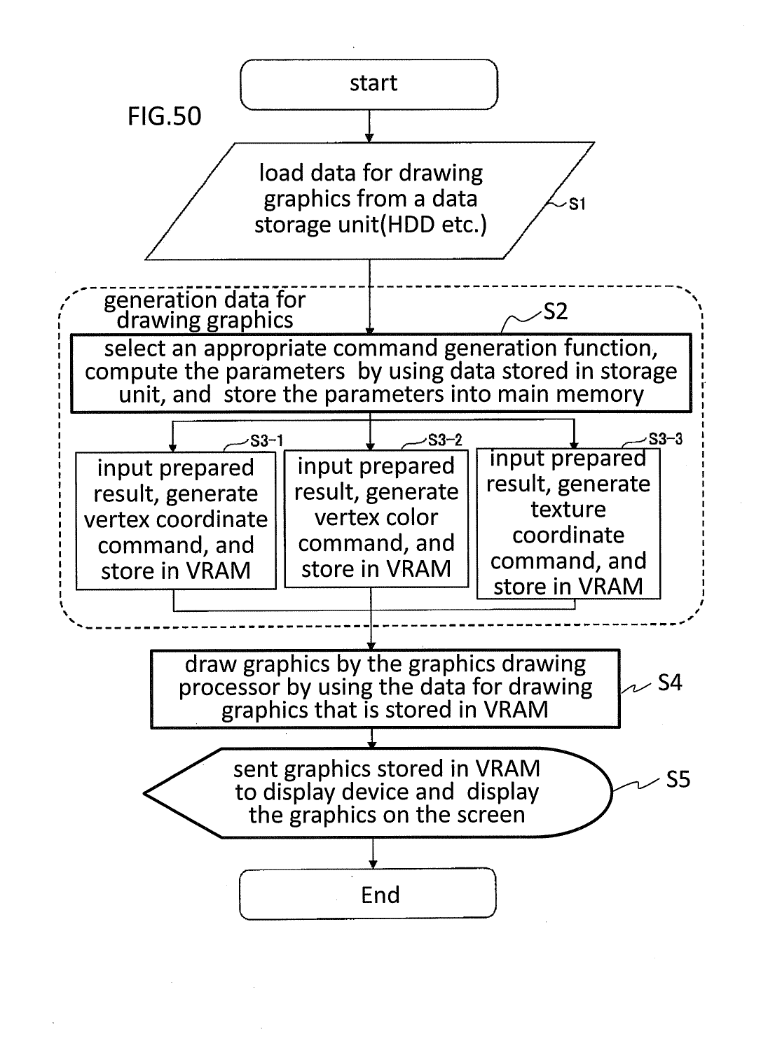

FIG. 50 is a flowchart illustrating a graphics drawing process using the multi-core CPU depicted in FIG. 49. The flowchart of FIG. 50 differs from the flowchart of FIG. 5 in that the flowchart of FIG. 50 includes steps S3-1 through S3-3 in place of step S3 of FIG. 5. In the flowchart of FIG. 50, the step (S3-1) of generating a vertex coordinate command, the step (S3-2) of generating a vertex color command, and the step (S3-3) of generating a texture coordinate command are performed by the multiple cores in parallel. The configuration may further improve the processing efficiency.

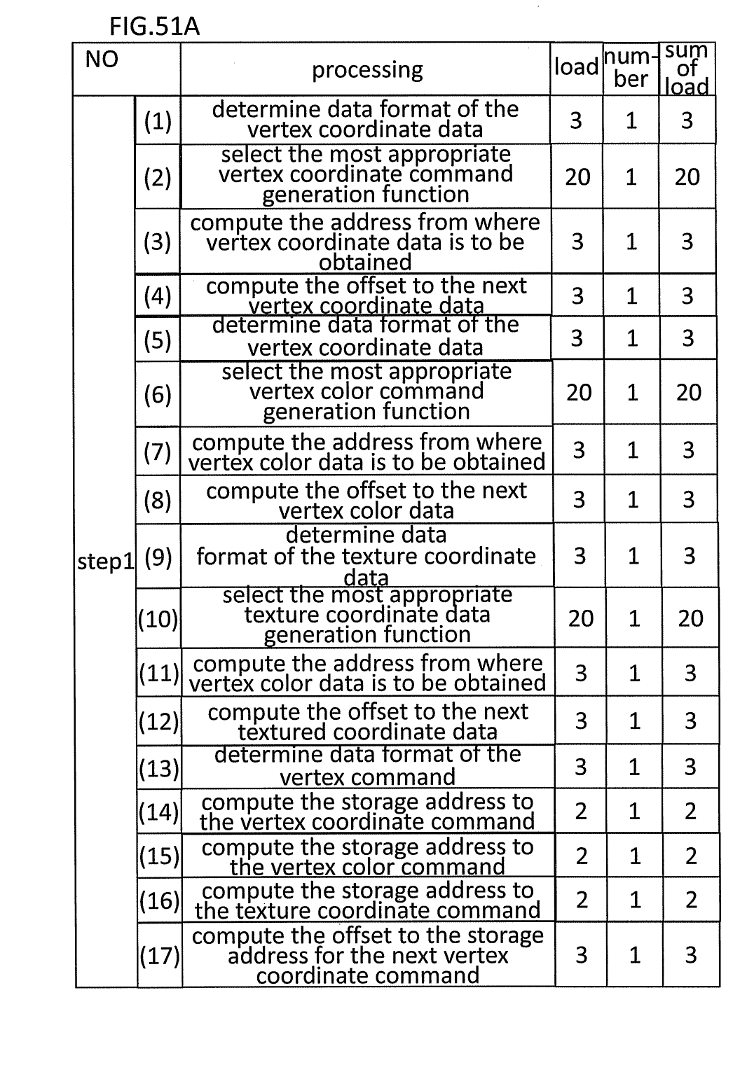

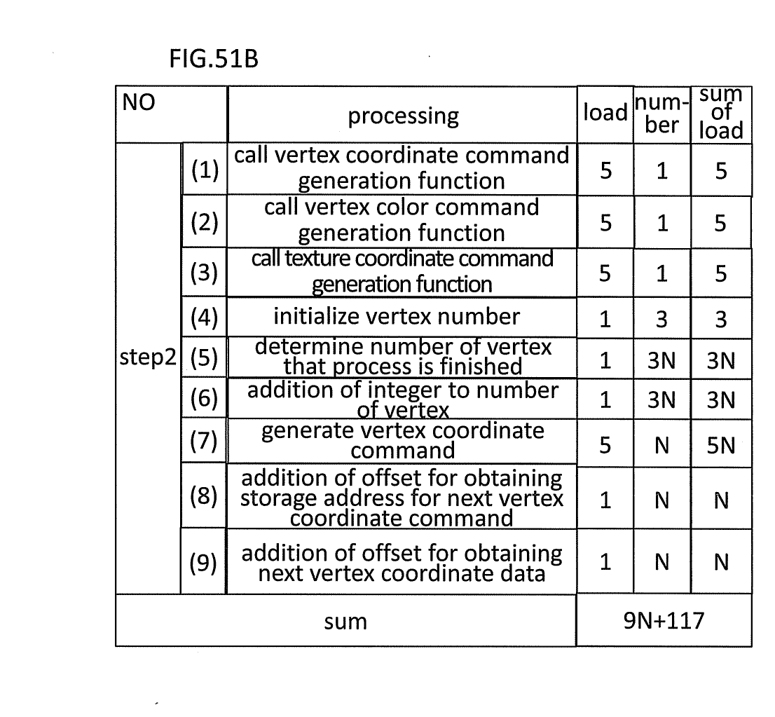

FIGS. 51A and 51B are a table illustrating processing loads in the graphics drawing data generation process at steps S2 and S3-1 through S3-3 of FIG. 50. As may be seen from FIGS. 51A and 51B, a processing load of 9N+117 in total is placed on the CPU 10A in the graphics drawing data generation process according to the exemplary embodiment illustrated in FIG. 50, where N is the number of vertices to be drawn. Therefore, if the number N of vertices to be drawn is large, the graphics drawing data generation process according to the exemplary embodiment has the advantage over the conventional process since the processing load is significantly smaller than that of the conventional process. Specifically, the processing load may be reduced by approximately 75% compared with the conventional process.

While the present invention has been described with respect to exemplary embodiments, the present invention is not limited to the exemplary embodiments described above. Various modifications may be made without departing from the scope defined in the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

What is claimed is:

1. A drawing data processing method in which if a plurality of lists including a first list on which first data in a first data format concerning a plurality of vertices are arranged vertex by vertex and a second list on which second data in a second data format concerning the plurality of vertices are arranged vertex by vertex are provided, data concerning each of the plurality of vertices are arranged for the plurality of vertices to generate a third list to be input in a drawing processor, the data including the first data represented in a third data format identical to or different from the first data format and the second data represented in a fourth data format identical to or different from the second data format, the method comprising:
selecting a first data generation process appropriate to the first and third data formats;
selecting a second data generation process appropriate to the second and fourth data formats;
computing an offset indicating the memory address distance between vertices on the third list according to at least the third and fourth data formats;
performing the first data generation process on the first data on the first list to generate the first data represented in the third data format for the plurality of vertices and writing the generated first data in a memory at intervals indicated by the offset;
performing the second data generation process on the second data on the second list to generate the second data represented in the fourth data format for the plurality of vertices and writing the generated second data in the memory at the intervals indicated by the offset;
wherein the method is performed by a processing unit.

2. The drawing data processing method according to claim 1, wherein the generating the first data represented in the third data format for the plurality of vertices and writing the generated first data in the memory at the intervals indicated by the offset is performed by calling a first function corresponding to the first data generation process and the step of generating the second data represented in the fourth data format for the plurality of vertices and writing the generated second data in the memory at the intervals indicated by the offset is performed by calling a second function corresponding to the second data generation process.

3. The drawing data processing method according to claim 2, wherein the first function further comprises reading the first data for the plurality of vertices from the first list at intervals indicated by a first offset, and
wherein the second function further comprises reading the second data for the plurality of vertices from the second list at intervals indicated by a second offset.

4. The drawing data processing method according to claim 1, wherein the generating the first data represented in the third data format for the plurality of vertices and writing the generated first data in the memory at the intervals indicated by the offset is performed by a first processing unit, and
wherein the generating the second data represented in the fourth data format for the plurality of vertices and writing the generated second data in the memory at the intervals indicated by the offset is performed by a second processing unit.

5. A graphics drawing system which, if a plurality of lists including a first list on which first data in a first data format concerning a plurality of vertices are arranged vertex by vertex and a second list on which second data in a second data concerning the plurality of vertices are arranged vertex by vertex are provided, arranges data concerning each of the plurality of vertices for the plurality of vertices to generate a third list to be input in a drawing processor, the data including the first data represented in a third data format identical to or different from the first data format and the second data represented in a fourth data format identical to or different from the second data format, the graphics drawing system comprising:
a processing unit;
a storage unit storing a program;
a drawing processor drawing an image on the basis of the third list; and a memory; wherein:
the program stored in the storage unit comprises a first program code causing the processing unit to perform the steps of:
selecting a first data generation process appropriate to the first and third data formats;
selecting a second data generation process appropriate to the second and fourth data formats;
computing an offset indicating the memory address distance between vertices on the third list according to at least the third and fourth data formats;
performing the first data generation process on the first data on the first list to generate the first data represented in the third data format for the plurality of vertices and writing the generated first data in a memory at intervals indicated by the offset;
performing the second data generation process on the second data on the second list to generate the second data represented in the fourth data format for the plurality of vertices and writing the generated second data in the memory at the intervals indicated by the offset

6. The graphics drawing system according to claim 5, wherein the generating the first data represented in the third data format for the plurality of vertices and writing the generated first data in the memory at the intervals indicated by the offset is performed by calling a first function corresponding to the first data generation process and the step of generating the second data represented in the fourth data format for the plurality of vertices and writing the generated second data in the memory at the intervals indicated by the offset is performed by calling a second function corresponding to the second data generation process.

7. The graphics drawing system according to claim 6, wherein the first function further comprises reading the first data for the plurality of vertices from the first list at intervals indicated by a first offset, and
wherein the second function further comprises reading the second data for the plurality of vertices from the second list at intervals indicated by a second offset.

8. The graphics drawing system according to claim 5, wherein the processing unit comprises first and second processing units, the generating the first data represented in the third data format for the plurality of vertices and writing the generated first data in the memory at the intervals indicated by the offset is performed by the first processing unit, and the generating the second data represented in the fourth data format for the plurality of vertices and writing the generated second data in the memory at the intervals indicated by the offset is performed by the second processing unit.

9. The graphics drawing system according to claim 5, wherein the program stored in the storage unit further comprises a second program code causing the processing unit to perform for each of the plurality of vertices in sequence the steps of:
selecting a third data generation process appropriate to the first and third data formats for a vertex of interest among the plurality of vertices;
performing the third data generation process on the first data on the vertex of interest on the first list to generate the first data represented in the third data format for the vertex of interest and store the generated first data in the memory; selecting a fourth data generation process appropriate to the second and fourth data formats for the vertex of interest; and
performing the fourth data generation process on the second data on the vertex of interest on the second list to generate the second data represented in the fourth data format for the vertex of interest and store the generated second data in the memory; and
the program causes the processing unit to perform one of the first and second program codes depending on the number of the plurality of vertices.
